(19) United States
(12) Patent Application Publication
(10) Pub. No.: US 2026/0153331 A1
(43) Pub. Date: Jun. 4, 2026

(54) METHOD AND SYSTEM FOR CONSTRUCTING A SPACEBORNE GNSS-R OCEAN SIGNIFICANT WAVE HEIGHT RETRIEVAL MODEL UNDER HIGH SEA CONDITIONS

(71) Applicant: Kunming University of Science and Technology, Kunming (CN)

(72) Inventors: Jinwei BU, Kunming (CN); Qiulan WANG, Kunming (CN); Ziyi WANG, Kunming (CN); Chaoying JI, Kunming (CN); Xinyu LIU, Kunming (CN); Youwen ZHAO, Kunming (CN); Hui YANG, Kunming (CN); Xin HE, Kunming (CN); Minghao HE, Kunming (CN); Shaoqiang FAN, Kunming (CN); Yutong WANG, Kunming (CN); Huan LI, Kunming (CN); Xiaoqing ZUO, Kunming (CN)

(21) Appl. No.: 19/196,633

(22) Filed: May 1, 2025

(30) Foreign Application Priority Data
Nov. 29, 2024 (CN) 202411732875.0

(51) Int. Cl. G01C 13/00; G01S 13/88

(52) U.S. Cl. CPC G01C 13/004; G01S 13/882

(57) ABSTRACT

Provided are a method and a system for constructing an ocean significant wave height retrieval model of spaceborne GNSS-R under high sea conditions, acquiring modeling data, auxiliary data and verification data; extracting characteristic variable parameters and auxiliary variable parameter of modeling data, and matching that extracted variable parameter in time and space; carrying out data quality control and data set division on the variable parameters after time-space matching; using the divided data set to construct and train the WaveMambaFormer model, and using the SHAP explainer to calculate the feature importance and global interpretation, so as to enhance the explainability of the WaveMambaFormer model; the significant wave height data of ERA5, WaveWatch III and Jason-3 are used as reference data to evaluate the retrieval performance of WaveMambaFormer model.

### CROSS-REFERENCE TO RELATED APPLICATIONS

This disclosure claims priority to Chinese Patent Application No. 202411732875.0 filed on Nov. 29, 2024, the contents of which are hereby incorporated by reference.

### TECHNICAL FIELD

The disclosure involves the multi-star spaceborne GNSS-R data ocean significant wave height retrieval technology field, and specifically, it relates to a method and system for constructing a spaceborne GNSS-R ocean significant wave height retrieval model under high sea conditions.

### BACKGROUND

Significant wave height (SWH) is one of the important indicators used in oceanography to describe wave conditions, which is used to assess the wave energy of the marine environment and the safety of ship navigation. Benefited by the continuous development and progress of science and technology, a new satellite remote sensing technology, the Global Navigation Satellite System Reflectometry (GNSS-R), is becoming an effective method to estimate SWH. Compared with traditional in situ measurement methods such as buoys or ships, which are limited by coverage area, spaceborne GNSS-R has significant advantages such as wide observation ranges, low observation cost, and all-weather and all-day measurement, making it a promising method for measuring SWH.

At present, the main methods for SWH estimation using spaceborne GNSS-R technology are SWH retrieval empirical models based on spaceborne GNSS-R observations and machine learning or deep learning methods. However, empirical model methods only consider limited input features, and moreover, due to the influence of various complex factors on the sea surface, it is difficult to characterize the relationship between SWH and GNSS-R eigenvalues with a simple empirical model. Machine learning or deep learning may deal with nonlinear problems and has significant advantages and potential in retrieving SWH, but conventional machine learning faces limitations in extracting advanced features; deep learning methods are based on deep neural networks and may handle complex data. Currently, some deep learning methods have been applied to retrieval SWH, and the retrieval accuracy of SWH has been greatly improved. However, in fact, the accuracy of SWH retrieval is still not very high in the current relevant studies, and the retrieval wave height range is small, because SWH is affected by many complex factors at the sea surface. In order to obtain higher accuracy of SWH retrieval, it is necessary to continuously improve the retrieval model and consider more auxiliary data affecting SWH. In addition, for deep learning models, their internal structures are usually complex and difficult to explain, quantifying the importance of each feature to the model prediction helps identify the most important and influential features, so as to optimize the selection of features, therefore, so the explainability of the model is also very important.

To sum up, since the SWH is affected by the various complex factors of the surface of the sea, in order to obtain higher retrieval accuracy and greater wave height retrieval accuracy, a new SWH depth learning retrieval model is needed to be built, and more SWH influences are considered. In addition, the explanation of the importance of model features is also crucial, Shapley Additive exPlanations (SHAP) may analyze the influence of each feature on the prediction results, quantify the importance of each feature to the model prediction. At the same time, by averaging the SHAP values of multiple samples helps understand the overall impact of features on the model prediction, and generate global feature importance analysis, and the explainability of deep learning models is enhanced.

### SUMMARY

In order to overcome the shortcomings of the existing spaceborne GNSS-R ocean significant wave height retrieval model, such as low retrieval accuracy and low retrieval efficiency, as well as the shortcomings of the current retrieval model based on deep learning using spaceborne GNSS-R technology, such as weak interpretation and insufficient feature interpretation, the disclosure provides a method and system for constructing a spaceborne GNSS-R ocean significant wave height retrieval model under high sea conditions, which is based on spaceborne GNSS-R technology is conjunction with SHAP explainer and fused with CNN. Transformer and State Space Model (SSM model) construct a hybrid network (called WaveMambaFormer model) to estimate the significant wave height of the ocean, which may greatly enhance the explainability of the model and improve the efficiency and retrieval accuracy of the model.

The disclosure provides a method for constructing a spaceborne GNSS-R ocean significant wave height retrieval model under high sea conditions characterized in that the method including:
S1, acquiring modeling data, auxiliary data and validating data, the modeling data includes: spaceborne GNSS-R data and ERA5 significant wave height data; the auxiliary data includes: ERA5 data, SMAP data and OSCAR data; and the validating data includes: significant wave height ERA5, WaveWatch III and Jason 3 significant wave height data;
S2, extracting spaceborne GNSS-R characteristic variable parameters and auxiliary variable parameters, and matching the parameters of the extracted variables by space-time;
S3, carrying out data quality control and data set division on the variable parameters after time-space matching;
S4, using the divided data set to construct and train the WaveMambaFormer model, and using SHAP explainer to calculate that importance of feature and global interpretation, and to enhance the explainability of WaveMambaFormer model;
S5, using ERA5, WaveWatch III and Jason-3 significant wave height data as reference data to evaluate the retrieval performance of WaveMambaFormer model.

In an embodiment, in the S2, extracting spaceborne GNSS-R characteristic variable parameters and auxiliary variable parameters, and matching the parameters of the extracted variables by space-time includes:
S2.1, the extracted spaceborne GNSS-R variable parameters include bistatic radar cross section (BRCS), effective scattering area (eff_scatter), DDM peak signal-to-noise ratio (Ddm_peak_snr), slope of DDM waveform leading edge (Ddm_sp_les), DDM specular reflection point normalization of bistatic radar cross section (Ddm_sp_nbres), normalized image signal-to-noise ratio (Ddm_sp_normalized_snr), signal-to-noise ratio of DDM specular reflection point (Ddm_sp_snr), DDM trajectory ID (Ddm_track_id), are used to generate GNSS satellite batch code Gnss_block_flag of DDM waveform, generate the GNSS satellite PRN code Gnss_prn_code of DDM waveform, an altitude Rx_alt of a low-orbit satellite corresponding to the intermediate time, a latitude Rx_lat of the low-orbit satellite corresponding to the DDM collecting intermediate time, a longitude Rx_lon of the low-orbit satellite corresponding to the DDM collecting intermediate moment, a pitch angle Rx_pitch of the low-orbit satellite corresponding to the DDM collecting intermediate time, a roll angle Rx_roll of the low-orbit satellite corresponding to the DDM collecting intermediate time, an X component Rx_vel_x of the low-orbit satellite speed corresponding to the DDM collecting intermediate time, a Y component Rx_vel_y of the low-orbit satellite velocity corresponding to the DDM collecting intermediate time, a Z component Rx_vel_z of the low-orbit satellite velocity corresponding to the DDM collecting intermediate time, a specular reflection point receiver antenna gain Sp_antenna_gain, an azimuth Sp_az_antenna of the specular reflection point in antenna coordinate system, the azimuth Sp_az_body of the specular reflection point in the satellite body coordinate system, azimuth Sp_az_orbit of the specular reflection point in orbital coordinate system, the azimuth Sp_az_pattern of the specular reflection point in the coordinate system of the pattern, incident angle Sp_inc_angle of GNSS signal at specular reflection point, the height Sp_alt of the specular reflection point, the latitude Sp_lat of the specular reflection point, the longitude Sp_lon of the specular reflection point, the height angle Sp_theta_antenna of the specular reflection point in the antenna coordinate system, the height angle Sp_theta_body of the specular reflection point in the satellite body coordinate system, the height angle Sp_theta_pattern of the specular reflection point in the pattern coordinate system, X component Sp_vel_x of the specular reflection point velocity, Y component Sp_vel_y of the specular reflection point velocity, Z component Sp_vel_z of the specular reflection point velocity, the X component Tx_vel_x of GNSS satellite speed at the signal transmission time corresponding to the DDM collecting intermediate time, DDM collects the Y component Tx_vel_y of GNSS satellite velocity at the signal transmission time corresponding to the DDM collecting intermediate time, the Z component Tx_vel_z of GNSS satellite velocity at the signal transmission time corresponding to the DDM collecting intermediate time;
S2.2, the characteristic variable parameters and metadata variables in the L1 level data of Tianmu-1 GPS-R/BDS-R/GLONASS-R/Galileo-R are matched with the significant wave height data of ERA5, ERA5 Wind speed EAR5 Rain rate and EAR5 sea surface temperature (STT), SMAP sea surface salinity (SSS) and OSCAR sea surface current data and ERA5 significant wave height data, WaveWatch III significant wave height data and Jason-3 significant wave height data in time and space, to obtain the data set after time and space matching.

In an embodiment, in the S3, data quality control of the variable parameters after time-space matching includes:
selecting the point of the specular reflection point on the ocean, setting SP_surface_type=0; the observed value must be positive, and the value needs to be discarded when the value is invalid Nan value; when the roll angle of the satellite is greater than 30°, the yaw angle is greater than 5°, or the pitch angle is greater than the absolute value of 10°, the data will be discarded; deleting the detection of radio frequency interference RFI data; if the uncertainty in the estimated specular point delay and Doppler shift exceeds the preset requirements, the data is deleted; if the altitude of the satellite is outside the nominal altitude range, the data is deleted; if the temperature and auto gain control values for the delayed Dopplergram DDM power calibration condition are out of the preset range, the data is deleted.

In an embodiment, in the S4, the WaveMambaFormer model includes of three models: the DDM feature extracting model based on CNN, the model Based on Transformer and the SSM model;
first, the local spatial information of the signal in the BRCS of a two-base radar scattering cross-section is extracted by a multilayer convolutional layer of CNN, the preset salient features are retained and the number of parameters is reduced using global average pooling after the convolution operation, and then the retained salient features are input into the Transformer to further capture long-range dependencies and temporal relationships; and the information in eff_scatter is extracted from the reflected signals by capturing the long-range dependencies between different time points through the self-attention mechanism; finally, the features are extracted from the variable parameters through the dynamic multipath SSM model.

In an embodiment, in the S4, training the WaveMambaFormer model includes:
introducing the Log-Cosine Loss Log-Cosh Loss function as a loss function, where the Log-Cosh Loss is calculated as:

$$L ( y , {y}^{p} ) = {\sum }_{i = 1}^{n} log ( cosh ( {y}_{i}^{p} - {y}_{i} ) )$$

in the formula

$${y}_{i}^{p}$$

denotes the predicted sea surface significant wave height and yᵢ denotes the reference significant wave height.

In an embodiment, in the S4, using SHAP explainer to calculate feature importance and global interpretation, and enhancing explainability of WaveMambaFormer model includes:
preparing the trained WaveMambaFormer model and data, creating the deep learning SHAP explainer DeepExplainer, then calculating SHAP value based on the test data, and carrying out the feature importance analysis and global interpretation by visualization methods; where, the visualization methods include: Summary plot, Waterfall Plot, Dependence plot and Heatmap plot.

In an embodiment, in the S5, using the significant wave height data of ERA5, WaveWatch III and Jason-3 are used as reference data respectively to evaluate the retrieval performance of WaveMambaFormer model includes:
using the root mean square error (RMSE), Bias, mean absolute percentage error (MAPE) and Pearson correlation coefficient R as indicators to evaluate the retrieval performance of the model, and putting into relevant calculation formulas as follows:

$$RMSE = \sqrt{\frac{1}{m} {\sum }_{i = 1}^{m} {( {y}_{i , M} - {y}_{i , T} )}^{2}}$$

$$Bias = \frac{1}{m} {\sum }_{i = 1}^{m} ( {y}_{i , M} - {y}_{i , T} )$$

$$MAPE = \frac{1}{m} {\sum }_{i = 1}^{m} \vert \frac{{y}_{i , M} - {y}_{i , T}}{{y}_{i , T}} \vert \times 100 \%$$

$$R = \frac{{\sum }_{i = 1}^{m} ( {y}_{i , M} - \overline{{y}_{m}} ) ( {y}_{i , T} - \overline{{y}_{T}} )}{\sqrt{{\sum }_{i = 1}^{m} {( {y}_{i , M} - \overline{{y}_{m}} )}^{2} {\sum }_{i = 1}^{m} {( {y}_{i , T} - \overline{{y}_{T}} )}^{2}}}$$

in the formula, m is the number of data samples, y_{i,M} and y_{i,T} are estimated the significant wave heights by the model and obtained from the reference data respectively, \sqrt{y_{M}} and y̅_̅{̅T̅}̅ are the averages of y_{i,M} and y_{i,T} respectively.

The disclosure also provides a system for constructing a spaceborne GNSS-R ocean significant wave height retrieval model under high sea conditions, the system is used to implement any of the methods, and the system includes: an acquiring model, an extracting model, a partitioning module, a constructing module and an evaluating module;
the acquisition model is used to acquire modeling data, auxiliary data and validation data, where the modeling data includes: spaceborne GNSS-R data and ERA5 significant wave height data; the auxiliary data includes: ERA5 data, SMAP data and OSCAR data; the validating data includes: ERA5, WaveWatch III and Jason-3 significant wave height data;
the extracting model is used to extract spaceborne GNSS-R characteristic variable parameters and auxiliary variable parameters, and matching the parameters of the extracted variables by space-time;
the partitioning model is used to carry out data quality control and data set partitioning on the variable parameters after time-space matching;
the constructing module uses the partitioned data set to construct and train the WaveMambaFormer model, uses SHAP explainer to calculate that importance of feature and global interpretation, and enhances the explainability of WaveMambaFormer model;
the evaluating model is used to evaluate the retrieval performance of WaveMambaFormer model by taking the significant wave height data of ERA5, WaveWatch III and Jason-3 as reference data respectively.

Compared with the prior art, the beneficial effects of the disclosure are:

The disclosure discloses a method and system for constructing a spaceborne GNSS-R ocean significant wave height retrieval model under high sea conditions, the retrieval model is called WaveMambaFormer, the explainability of the model is enhanced by the Shapley Additive exPlanations (SHAP) explainer, the system mainly includes of three major models, a DDM feature extracting module based on CNN, a Transformer model and State Space Model, (SSM). The method includes the following steps: acquiring modeling data (including spaceborne GNSS-R data and ERA5 significant wave height data), auxiliary data (ERA5 data, SMAP data and OSCAR data) and validating data (ERA5, WaveWatch III and Jason-3 significant wave height data); extracting spaceborne GNSS-R characteristic variable parameters and auxiliary variable parameters, and matching the dataset by space-time; filtering data and controlling data quality control and partitioning data set; constructing and training WaveMambaFormer model, and using SHAP explainer to calculate feature importance and global interpretation to enhance the explainability of the model; and using ERA5, WaveWatch III and Jason-3 the significant wave height data as reference data to evaluate the retrieval performance of the model. The retrieval model constructed by the disclosure is able to significantly improve the accuracy of ocean significant wave height under high sea conditions, expand the wave height range of significant wave height retrieval, and at the same time explain the importance of model features, providing a new method for using spaceborne GNSS-R data to retrieve ocean significant wave height under high sea conditions.

### BRIEF DESCRIPTION OF THE DRAWINGS

In order to more clearly state the technical scheme of the disclosure, the drawings required for use in the embodiments are briefly introduced below, it is evident that the drawings described below are only embodiments of the disclosure, and that other drawings may be obtained from them without creative labor by persons of ordinary skill in the art.

FIG. 1 is a flow chart of a method for constructing a spaceborne GNSS-R ocean significant wave height retrieval model under high sea conditions provided in the embodiment of the disclosure.

FIG. 2 is the WaveMambaFormer model structure diagram in the embodiment of the disclosure.

FIG. 3 is the SHAP waterfall plot in the embodiment of the disclosure.

FIG. 4A, FIG. 4B, FIG. 4C, FIG. 4D are the comparison accuracy of retrieval significant wave height of different models and ERA5 data in different significant wave height intervals in the implementation cases of the disclosure, of which FIG. 4A is RMSE; FIG. 4B is Bias; FIG. 4C is MAPE; and FIG. 4D is R.

FIG. 5A, FIG. 5B, FIG. 5C, FIG. 5D are the comparison accuracy of retrieval significant wave height with WaveWatch III data in different significant wave height intervals of different models in the implementation cases of the disclosure, of which FIG. 5A is RMSE; FIG. 5B is Bias; FIG. 5C is MAPE; and FIG. 5D is R.

FIG. 6A, FIG. 6B, FIG. 6C, FIG. 6D are the comparison accuracy of retrieval significant wave height with Jason-3 c band data in different significant wave height intervals of different models in the implementation case of the disclosure, of which FIG. 6A is RMSE; FIG. 6B is Bias; FIG. 6C is MAPE; and FIG. 6D is R.

FIG. 7A, FIG. 7B, FIG. 7C, FIG. 7D are the accuracy of retrieval of significant wave height with Jason-3 ku band data in different significant wave height intervals in different implementation cases of the disclosure, of which FIG. 7A is RMSE; FIG. 7B is Bias; FIG. 7C is MAPE; and FIG. 7D is R.

### DETAILED DESCRIPTION OF THE EMBODIMENTS

The following is a clear and complete description of the technical scheme in the embodiments of the disclosure in combination with the drawings attached to the embodiment of the disclosure. Obviously, the described embodiments are only some embodiments of the disclosure, but not the whole embodiments. Based on the embodiments of the disclosure, all other embodiments obtained by ordinary technicians in the field without making creative labor fall within the scope of protection of the disclosure.

It should be noted that, unless otherwise defined, the technical or scientific terms used in this disclosure shall have the usual meaning understood by persons of general skill in the field to which the disclosure belongs. The terms “first”, “second”, and similar expressions used in this disclosure do not imply any order, quantity, or importance, but are used only to distinguish between different components. Words such as “including” or “containing” mean that the component or object present before the word covers the component or object listed after the word and its equivalent, and does not exclude other components or objects. The term “connect” or “link” is not limited to physical or mechanical connections, but may include electrical connections, whether direct or indirect. “up”, “down”, “left”, “right”, etc., are used only to indicate the relative position relationship. When the absolute position of the described object changes, the relative position relationship may also change accordingly.

In order to make the above purposes, features and advantages of the disclosure more obvious and understandable, the disclosure is further explained in detail in combination with the attached drawings and specific embodiments.

### Embodiment 1

The disclosure is able to effectively improve the performance of the wave height retrieval model by integrating CNN, Transformer and SSM, using CNN's local feature extraction, Transformer's global dependence modeling and SSM's dynamic modeling advantages, the prediction accuracy, robustness and adaptability of the model to complex wave patterns are improved. This comprehensive method may provide strong support for the significant wave height retrieval task in space-borne GNSS-R data, especially when dealing with wave data with temporal and spatial complexity, showing great advantages.

In addition, the combination of CNN (Convolutional Neural Network), Transformer and State Space Model (SSM) for the construction of significant wave height retrieval model has the following main advantages:

### (1) Advantages of CNN: Extracting Local Features;

1) Strong local feature extracting ability: CNN is good at extracting local features from DDM image data. In the retrieval of significant wave height, CNN may effectively extract these local features through convolution operation. 2) Spatial information reservation: when processing spatial data, CNN may retain important spatial information through convolution layer, and it is helpful to identify local patterns and structures of waves.

### (2) Advantages of Transformer: Modeling Global Dependencies

1) Long-distance dependency modeling capability: Transformer is able to capture the global dependence in long time series or space through self-attention mechanism. In the retrieval of significant wave height, the evolution of waves is influenced by many time and space factors. Transformer is able to effectively model these long-range dependencies, especially for tasks that need global context information.
2) Parallel processing: different from traditional RNN and LSTM, Transformer may process data in parallel, which greatly improves the training efficiency. This is very useful for large-scale time series data processing and wave height retrieval.
(3) Advantages of SSM: modeling dynamic systems

Dynamic system modeling ability: SSM is particularly good at modeling hidden state changes in dynamic processes. In the inverse problem of significant wave height, the wave change process is a dynamic system, and SSM may effectively capture the hidden state in time series and the dynamic characteristics of wave evolution.

Smoothness and robustness: through the state space model, smooth estimation and state estimation are performed under the condition of incomplete observation data or large noise, and the robustness and accuracy of the model are improved.

### (4) Advantages of Model Fusion: Complementary Advantages

1) Comprehensive feature extraction and modeling capabilities: by combining CNN's local feature extraction ability, Transformer's global dependency modeling ability and SSM's dynamic modeling ability, may make full use of the advantages of different models in significant wave height retrieval. CNN is able to extract fine-grained local wave features, Transformer is able to capture the long-term evolution of waves, and SSM is able to smooth the time dynamic changes of waves.
2) Improve the prediction accuracy: this multi-model fusion strategy is able to effectively capture the spatial and temporal characteristics of waves and improve the overall accuracy and generalization ability of the significant wave height retrieval model.

### (5) Adapt to Complex Wave Environment (Such as High Sea Conditions)

Dealing with complex wave patterns: wave height retrieval model needs to consider a variety of complex wave environment and interference factors, such as wind speed, rainfall and other external conditions. By integrating CNN, Transformer and SSM, these complex influencing factors may be modeled more comprehensively and the adaptability of the model to different wave modes may be enhanced.

### (6) Efficiency and Scalability

Model optimization and accuracy improvement: by combining these advanced network structures, the prediction accuracy may be improved and the calculation efficiency may be guaranteed. Transformer's parallel processing ability and CNN's feature extraction ability help to speed up the training process, while SSM may effectively model dynamic systems, reducing the demand for computing resources.

Therefore, the disclosure provides a method for constructing a spaceborne GNSS-R ocean significant wave height retrieval model under high sea conditions, specifically, it is the first time to put forward a WaveMambaFormer model that combines CNN, Transformer and SSM for the retrieval of ocean significant wave heights under high sea conditions, and to enhance the explainability of the model through the SHAP explainer.

The specific implementation process includes: the disclosure relates to a method for constructing an ocean significant wave height retrieval model by fusing China Tianmu-1 space borne GPS-R/BDS-R/GLONASS-R/Galileo-R data under high sea conditions, the method includes the following steps:
S1, acquiring modeling data (including spaceborne GNSS-R data and ERA5 significant wave height data), auxiliary data (including ERA5 data, SMAP data and OSCAR data) and validating data (including ERA5, WaveWatch III and Jason-3 significant wave height data);
S2, extracting spaceborne GNSS-R characteristic variable parameters and auxiliary variable parameters, and matching the parameters of the extracted variables by space-time;
S3, data filtering and data quality control and data set partitioning;
S4, constructing and training WaveMambaFormer model, and using SHAP explainer to calculate feature importance and global interpretation, and to enhance the explainability of the model; and
S5, using ERA5, WaveWatch III and Jason-3 significant wave height data as reference data to evaluate the retrieval performance of the model, using root mean square error (RMSE), Bias, mean absolute percentage error (MAPE) and using Pearson correlation coefficient (R2) an index to evaluate the retrieval performance of the model.

In an embodiment, in the S1, the spaceborne GNSS-R data in the adopted modeling data is the L1-level data of Tianmu-1 GPS-R/BDS-R/GLONASS-R/Galileo-R (provided by Aerospace Tianmu (Chongqing) Satellite Technology Co., Ltd. and Aerospace Science and Technology (Beijing) Space Information Application Co., Ltd. for free), ERA5 data in the auxiliary data includes EAR5 Wind speed, EAR5 Rain rate and EAR5 SST data, SMAP data include SMAP sea surface salinity (SSS), OSCAR data is OSCAR ocean current (OSCAR_currents) includes the east-west velocity (OSCAR_currents_u) and the north-south velocity (OSCAR_currents_v).

In an embodiment, the S2 includes the following substeps:
S2.1, the extracted spaceborne GNSS-R variable parameters includes bistatic radar cross section (BRCS), effective scattering area (eff_scatter), DDM peak signal-to-noise ratio (Ddm_peak_snr), slope of DDM waveform leading edge (Ddm_sp_les), DDM specular reflection point normalization of bistatic radar cross section (Ddm_sp_nbres), normalized image signal-to-noise ratio (Ddm_sp_normalized_snr), signal-to-noise ratio of DDM specular reflection point (Ddm_sp_snr), DDM trajectory ID (Ddm_track_id), are used to generate GNSS satellite batch code Gnss_block_flag of DDM waveform, the GNSS satellite PRN code Gnss_prn_code of DDM waveform, an altitude Rx_alt of a low-orbit satellite corresponding to the DDM collecting intermediate time, a latitude Rx_lat of the low-orbit satellite corresponding to the DDM collecting intermediate time, a longitude Rx_lon of the low-orbit satellite corresponding to the DDM collecting intermediate moment, DDM collects a pitch angle Rx_pitch of the low-orbit satellite corresponding to the intermediate time, a roll angle Rx_roll of the low-orbit satellite corresponding to the DDM collecting intermediate time, an X component Rx_vel_x of the low-orbit satellite speed corresponding to the DDM collecting intermediate time, a Y component Rx_vel_y of the low-orbit satellite velocity corresponding to the DDM collecting intermediate time, a Z component Rx_vel_z of the low-orbit satellite velocity corresponding to the DDM collecting intermediate time, a specular reflection point receiver antenna gain Sp_antenna_gain, an azimuth Sp_az_antenna of the specular reflection point in antenna coordinate system, the azimuth Sp_az_body of the specular reflection point is in the satellite body coordinate system, an azimuth Sp_az_orbit of the specular reflection point in orbital coordinate system, the azimuth Sp_az_pattern of the specular reflection point in the coordinate system of the pattern, incident angle Sp_inc_angle of GNSS signal at specular reflection point, the height Sp_alt of the specular reflection point, the latitude Sp_lat of the specular reflection point, the longitude Sp_lon of the specular reflection point, the height angle Sp_theta_antenna of the specular reflection point in the antenna coordinate system, the height angle Sp_theta_body of the specular reflection point in the satellite body coordinate system, the height angle Sp_theta_pattern of the specular reflection point in the pattern coordinate system, X component Sp_vel_x of the specular reflection point velocity, Y component Sp_vel_y of the specular reflection point velocity, Z component Sp_vel_z of the specular reflection point velocity, X component Tx_vel_x of GNSS satellite speed at the signal transmission time corresponding to the DDM collecting intermediate time, Y component Tx_vel_y of GNSS satellite velocity at the signal transmission time corresponding to the DDM collecting intermediate time, Z component Tx_vel_z of GNSS satellite velocity at the signal transmission time corresponding to the DDM collecting intermediate time;
S2.2, the characteristic variable parameters and metadata variables in the L1 level data of Tianmu-1 GPS-R/BDS-R/GLONASS-R/Galileo-R are matched with the significant wave height data of ERA5, ERA5 Wind speed, EAR5 Rain rate and EAR5 sea surface temperature (SST), SMAP sea surface salinity (SSS) and OSCAR sea surface current data and ERA5 significant wave height data, WaveWatch III significant wave height data and Jason-3 significant wave height data in time and space, to obtain the data set after time and space matching is obtained.

In an embodiment, the S3 includes the following substeps:
S3.1, data filtering is to use basic quality control (QC) flag in Tianmu-1 GNSS-R L1 data, and apply data filtering with a single QC flag bit. Data quality control includes selecting the point of specular reflection point on the ocean (that is, setting SP_surface_type=0); the observed value must be positive, and it needs to be discarded when the value is Nan; when the roll angle of the satellite is greater than 30°, the yaw angle is greater than 5°, or the pitch angle is greater than the absolute value of 10°, the data will be discarded; deleting the detected radio frequency interference (RFI) data; if the uncertainty in the estimated specular point delay and Doppler shift exceeds the preset requirements, the data is deleted; if the altitude of the satellite is out of the nominal altitude range, the data is deleted; if the temperature and auto gain control values for the delayed Dopplergram DDM power calibration condition are out of the preset range, the data is deleted.
S3.2, the data set is divided according to the training set accounting for 60% of the total data set and the test set accounting for 40% of the total data set.

In an embodiment, the S4 includes the following substeps:
S4.1, the constructed significant wave height retrieval model is called WaveMambaFormer, the model includes of three models: the DDM feature extraction model based on CNN, Transformer model and State Space model (SSM). CNN is very suitable for the processing of local features in images or signals, Transformer has a unique self-attention mechanism, which may capture long-time scale or long-distance dependencies in signals, the dynamic modeling ability, noise suppression ability and adaptability to time-varying processes of SSM model are particularly suitable for describing the complexity and variability of sea surface state. Specifically, firstly, the local spatial information of signals in BRCS is extracted through CNN's multi-layer convolution layer. After convolution operation, using global average pooling may preserve significant features and reduce the amount of parameters, which greatly improves the training speed of the model. Then, these features are input into Transformer to further capture the long-distance dependence and time series relationship; secondly, due to the highly nonlinear relationship between the fluctuation of ocean surface and the scattering of reflected signals, Transformer may handle this complex relationship and capture the long-range dependence between different time points through the self-attention mechanism, so as to extract the information in eff_scatter from reflected signals more accurately; finally, the features are extracted from the variable parameters through the dynamic multipath SSM model.

The main part of Transformer module is encoder module, which is used to extract global information. It includes of multi-head attention mechanism, residual connection and Layer Normalization, feedforward neural network and fully connected network. The multi-head attention mechanism includes of multiple self-attention mechanisms, for a single self-attention mechanism, if the input vector matrix is represented by X∈□^{N×D}, then Q ((query), K (key value) and V (value) are obtained by multiplying the input matrix X with three learnable weight matrices W^{Q}, W^{K} and W^{V}, the relevant calculation formulas are as follows:

$$Q = X {W}^{Q} \qquad ( 1 )$$

$$K = X {W}^{K} \qquad ( 2 )$$

$$V = X {W}^{V} \qquad ( 3 )$$

After obtaining the matrices Q, K and V, the output of Self-Attention mechanism may be calculated, and the calculation formula is as follows:

$$Self - Attention ( Q , K , V ) = ( \frac{Q {K}^{T}}{\sqrt{{d}_{k}}} ) V . \qquad ( 4 )$$

In the formula, dₖ is the number of columns of the Q and K matrix.

Residual connection may transfer gradient between different layers, effectively alleviating the problem of gradient disappearance. Layer normalization is helpful to accelerate the convergence speed of the model in the training stage and improve the generalization ability of the model.

SSM is able to describe the dynamic changes of the system, especially suitable for time-dependent data modeling, and may handle multiple variables and their interaction at the same time, which is suitable for the modeling of complex systems. SSM comes from the control system theory. The continuous function treated by the original theory includes the state equation and the observation equation. The calculation expression is as follows:

$${h}^{′} ( t ) = Ah ( t ) + Bx ( t ) \qquad ( 5 )$$

$$y ( t ) = Ch ( t ) \qquad ( 6 )$$

In the formula, x(t) is the input sequence, h(t) is the hidden state, and y(t) is the predicted output sequence. SSM is applied to deep learning in discrete form, A and B are discretized by zero-order preserving (ZOH) method, and the time scale parameter is Δ.

$$\overline{A} = exp ( Δ A ) \qquad ( 7 )$$

$$\overline{B} = {( Δ A )}^{- 1} ( exp ( Δ A ) - I ) \cdot Δ B . \qquad ( 8 )$$

After discretization, formulas (1) and (2) may be rewritten as:

$${h}_{k} = \overline{A} {h}_{k - 1} + \overline{B} {x}_{k} \qquad ( 9 )$$

$${y}_{k} = \overline{C} {h}_{k} \qquad 10 )$$

The final output y is obtained by the following calculation formula:

$$\overline{K} = ( \overline{C} \overline{B} , \overline{C} \overline{A} \overline{B} , … , \overline{C} {\overline{A}}^{L - 1} \overline{B} ) \qquad ( 11 )$$

$$y = x * \overline{K} \qquad ( 12 )$$

In the formula, L represents the length of the input sequence and K̅ represents the structured convolution kernel.

In the process of model training, MSE or MAE are usually used as the loss function, but they have their own defects. MSE is very sensitive to outliers because the square term will amplify large errors. MAE is robust to outliers, but it will show the problem of gradient discontinuity where the error is close to 0. However, Log-Cosh has less penalty for outliers than MSE, and the gradient changes smoothly when the error approaches 0. Log-Cosh Loss function combines the smoothness of mean square error (MSE) and the robustness of mean absolute error (MAE), which may not only effectively optimize small errors, but also avoid the excessive influence of outliers on the model. The function is especially suitable for the regression task in deep learning model, and may give consideration to high accuracy and robustness. Therefore, the Log-cosine loss function is introduced as the loss function, and the calculation formula of Log-cosine loss is as follows:

$$L ( y , {y}^{p} ) = {\sum }_{i = 1}^{n} log ( cosh ( {y}_{i}^{p} - {y}_{i} ) ) \qquad ( 13 )$$

In the formula,

$${y}_{i}^{p}$$

represents the predicted significant wave height and yᵢ represents the reference significant wave height.
S4.2, SHAP (SHapley Additional exPlanations) explainer is used to calculate the importance of features and the global explanation, which enhances the explainability of the model. It usually includes the following steps: preparing the trained WaveMambaFormer model and data, creating a deep learning SHAP explainer, then the SHAP value is calculated based on the test data, and the feature importance is analyzed and explained globally by visual methods (Summary plot, Waterfall Plot, Dependence plot and Heatmap plot).
S4.3, the characteristic variables and metadata variables in the L1 data of Tianmu-1 GPS-R/BDS-R/GLONASS-R/Galileo-R, and the data of ERA5 Wind speed, ERA5 Rain rate, ERA5 sea surface temperature (SST), SMAP sea surface salinity (SSS) and OSCAR sea current are used as the input data for the training of the WaveMambaFormer model, ERA5 significant wave height data is taken as target data, where, the GNSS satellite batch code (Gnss_block_flag) used to generate DDM waveform is helpful to fuse GPS-R/BDS-R/GLONASS-R/Galileo-R data to realize multi-constellation GNSS-R and construct significant wave height retrieval model.

In an embodiment, in the S5, the retrieval performance of the model is evaluated by using ERA5, WaveWatch III and Jason-3 significant wave height products as reference data respectively. Root mean square error (RMSE), deviation (Bias), mean absolute percentage error (MAPE) and Pearson correlation coefficient (R) are used as indicators to evaluate the retrieval performance of the model, and the relevant calculation formulas are as follows:

$$R M S E = \sqrt{\frac{1}{m} {\sum }_{i = 1}^{m} {( {y}_{i , M} - {y}_{i , T} )}^{2}} \qquad ( 14 )$$

$$Bias = \frac{1}{m} {\sum }_{i = 1}^{m} ( {y}_{i , M} - {y}_{i , T} ) \qquad ( 15 )$$

$$MAPE = \frac{1}{m} {\sum }_{i = 1}^{m} \vert \frac{{y}_{i , M} - {y}_{i , T}}{{y}_{i , T}} \vert \times 100 \% \qquad ( 16 )$$

$$R = \frac{{\sum }_{i = 1}^{m} ( {y}_{i , M} - \overline{{y}_{M}} ) ( {y}_{i , T} - \overline{{y}_{T}} )}{\sqrt{{\sum }_{i = 1}^{m} {( {y}_{i , M} - \overline{{y}_{M}} )}^{2} {\sum }_{i = 1}^{m} {( {y}_{i , T} - \overline{{y}_{T}} )}^{2}}} \qquad ( 17 )$$

in the formula, m is the number of data samples, y_{i,M} and y_{i,T} are estimated the significant wave heights by the model and obtained from the reference data respectively, y̅_̅{̅M̅}̅ and y̅_̅{̅T̅}̅ are the averages of y_{i,M} and y_{i,T} respectively.

It should be noted that the method of the embodiment of the disclosure may be executed by a single device, such as a computer or a server. The method of this embodiment may also be applied to a distributed scenario, which is completed by the cooperation of multiple devices. In this distributed scenario, one of the devices may only perform one or more steps in the method of the embodiment of the disclosure, and the devices will interact with each other to complete the method.

It should be noted that some embodiments of the disclosure have been described above. Other embodiments are within the scope of the appended claims. In some cases, it should be understood that the size of the sequence number of each step in the above-mentioned embodiment does not mean the order of execution, and the order of execution of each process should be determined according to its function and internal logic, and should not constitute any restrictions on the implementation process of the embodiment of the disclosure. The actions or steps recited in the claims may be performed in a different order than in the above embodiments and still achieve the desired results. In addition, the processes depicted in the drawings do not necessarily require the specific order shown or the sequential order to achieve the desired results. In some embodiments, multitasking and parallel processing are also possible or may be advantageous.

### Embodiment 2

Based on the same inventive concept, corresponding to the method of any of the above embodiments, the disclosure also provides a system for constructing a spaceborne GNSS-R ocean significant wave height retrieval model under high sea conditions, the system is used for realizing any one of the methods, and includes an acquisition model, an extraction model, a division model, a construction model and an evaluating model;
the acquisition model is used to acquire modeling data, auxiliary data and validation data, where the modeling data includes: spaceborne GNSS-R data and ERA5 significant wave height data; the auxiliary data includes: ERA5 data, SMAP data and OSCAR data; the validating data includes: significant wave height data of ERA5, WaveWatch III and Jason-3;
the extracting model is used to extract spaceborne GNSS-R characteristic variable parameters and auxiliary variable parameters, and matching the parameters of the extracted variables by space-time;
the partitioning module is used to carry out data quality control and data set division on the variable parameters after time-space matching;
the constructing module uses the partitioned data set to construct and train the WaveMambaFormer model, and using SHAP explainer to calculate that importance of feature and global interpretation, enhance the explainability of WaveMambaFormer model;
the evaluating model is used to evaluate the retrieval performance of WaveMambaFormer model by taking the significant wave height data of ERA5, WaveWatch III and Jason-3 as reference data respectively.

The system in the above embodiment is used to realize the corresponding the method for constructing a spaceborne GNSS-R ocean significant wave height retrieval model under high sea conditions in any of the above embodiments, and has the beneficial effects of the corresponding method embodiment, so it is not repeated here.

It should be noted that the above-mentioned spaceborne GNSS-R ocean significant wave height retrieval model construction system under high sea conditions is embodied in the form of functional units. The term “model” here may be implemented in the form of software and/or hardware, and it is not specifically limited.

For example, a “model” may be a software program, a hardware circuit or a combination of both. A hardware circuit may include a disclosure specific integrated circuit (ASIC), an electronic circuit, a processor (e.g., a shared processor, a proprietary processor or a group processor, etc.) and a memory for executing one or more software or firmware programs, a combinational logic circuit, and/or other suitable components to support the described functions.

### Embodiment 3

The disclosure provides a method for constructing an ocean significant wave height retrieval model integrating China Tianmu-1 spaceborne GPS-R/BDS-R/GLONASS-R/Galileo-R data under high sea conditions, which will be described in detail with the attached drawings:

In order to verify the validity of the method proposed by the disclosure, the L1-level data of Tianmu-1 GPS-R/BDS-R/GLONASS-R/Galileo-R from March 2024 to April 2024 (provided by Aerospace Tianmu (Chongqing) Satellite Technology Co., Ltd. and Aerospace Science and Technology (Beijing) Space Information Application Co., Ltd. free of charge) and ERA5 significant wave height data are selected, ERA5 Wind speed data, ERA5 Rain rate data, ERA5 sea surface temperature (SST) data, SMAP sea surface salinity (SSS) data, OSCAR sea surface current (OSCAR_currents) data and ERA5, WW3 and Jason-3 significant wave heights data, where, the L1 data of Tianmu-1 GPS-R/BDS-R/GLONASS-R/Galileo-R and the significant wave height data of ERA5 are used to establish the model; ERA5 Wind speed data, ERA5 Rain rate data, ERA5 sea surface temperature (SST) data, SMAP sea surface salinity (SSS) data and OSCAR sea surface current (OSCAR_currents) data as auxiliary data; ERA5 significant wave height data, WaveWatch III significant wave height data and Jason-3 significant wave height data are used as reference data respectively, and five indexes, namely root mean square error (RMSE), Bias, mean absolute percentage error (MAPE), determination coefficient (R2) and Pearson correlation coefficient (R), are used to evaluate the retrieval performance of the model. The basic configuration of the experimental platform of this embodiment is shown in Table 1:

TABLE 1
Configuration of Experimental Platform

| Programming Language | Python 3.8 |
|---|---|
| Deep Learning API | Tensorflow 2.6 & Keras 2.6 |
| CPU | 13th Gen Intel core i7-13700KF |
| Random Access Memory | 64 GB (Kingston DDR4 3200 MHz 32 GB × 2) |
| GPU | NVIDIA GeForce RTX 4070 |

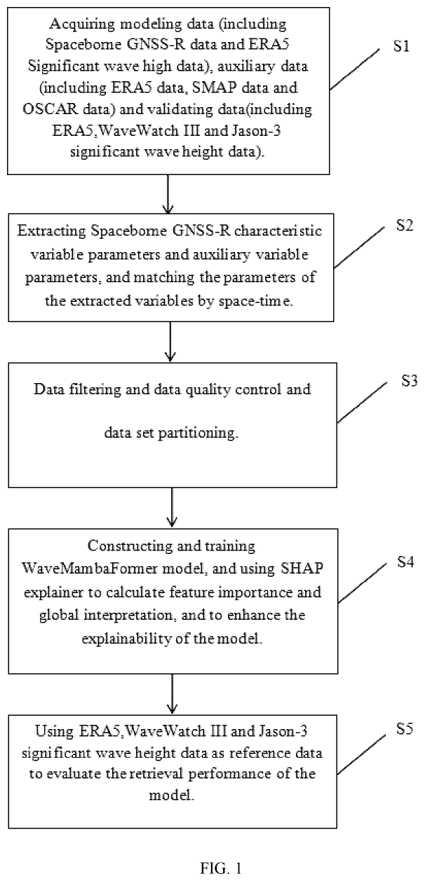

A method for constructing an ocean significant wave height retrieval model by fusing China Tianmu-1 spaceborne GPS-R/BDS-R/GLONASS-R/Galileo-R data under high sea conditions is provided, and the implementation flow of the technical scheme is shown in FIG. 1, and includes the following steps:
S1, obtaining modeling data, auxiliary data and validating data, where, the modeling data (includes: spaceborne GNSS-R data and ERA5 significant wave height data); the auxiliary data (including ERA5 data, SMAP data and OSCAR data) and the validating data (including significant wave height data of ERA5, WaveWatch III and Jason 3);
S2, extracting spaceborne GNSS-R characteristic variable parameters and auxiliary variable parameters, and matching the parameters of the extracted variables by space-time;
S3, carrying out data quality control and data set division on the variable parameters after time-space matching;
S4, using the divided data set to construct and train the WaveMambaFormer model, and using SHAP explainer to calculate that importance of feature and global interpretation, enhance the explainability of WaveMambaFormer model; and
S5, the significant wave height data of ERA5, WaveWatch III and Jason-3 are used as reference data to evaluate the retrieval performance of WaveMambaFormer model.

As an implementation of this embodiment, in the S1, the spaceborne GNSS-R data in the adopted modeling data is the L1-level data of Tianmu-1 GPS-R/BDS-R/GLONASS-R/Galileo-R (provided by Aerospace Tianmu (Chongqing) Satellite Technology Co., Ltd. and Aerospace Science and Technology (Beijing) Space Information Application Co., Ltd. for free), ERA5 data in the auxiliary data includes Wind speed, Rain rate and SST data of ERA5, SMAP data include SMAP sea surface salinity (SSS), OSCAR data is OSCAR ocean current (OSCAR_currents) includes the east-west velocity (OSCAR_currents_u) and the north-south velocity (OSCAR_currents_v).

As an implementation of this embodiment, the S2 includes the following substeps:
S2.1, the extracted spaceborne GNSS-R variable parameters includes bistatic radar cross section (BRCS), effective scattering area (eff_scatter), DDM peak signal-to-noise ratio (Ddm_peak_snr), slope of DDM waveform leading edge (Ddm_sp_les), DDM specular reflection point normalization of bistatic radar cross section (Ddm_sp_nbres), normalized image signal-to-noise ratio (Ddm_sp_normalized_snr), signal-to-noise ratio of DDM specular reflection point (Ddm_sp_snr), DDM trajectory ID (Ddm_track_id), are used to generate GNSS satellite batch code Gnss_block_flag of DDM waveform, are used to generate the GNSS satellite PRN code Gnss_prn_code of DDM waveform, DDM collects an altitude Rx_alt of a low-orbit satellite corresponding to the intermediate time, DDM collects a latitude Rx_lat of the low-orbit satellite corresponding to the intermediate time, DDM collects a longitude Rx_lon of the low-orbit satellite corresponding to the intermediate moment, DDM collects a pitch angle Rx_pitch of the low-orbit satellite corresponding to the intermediate time, DDM collects a roll angle Rx_roll of the low-orbit satellite corresponding to the intermediate time, DDM collects a X component Rx_vel_x of the low-orbit satellite speed corresponding to the intermediate time, DDM collects a Y component Rx_vel_y of the low-orbit satellite velocity corresponding to the intermediate time, DDM collects a Z component Rx_vel_z of the low-orbit satellite velocity corresponding to the intermediate time, a specular reflection point receiver antenna gain Sp_antenna_gain, azimuth Sp_az_antenna of the specular reflection point in antenna coordinate system, the specular reflection point is in the azimuth Sp_az_body of the satellite body coordinate system, an azimuth Sp_az_orbit of the specular reflection point in orbital coordinate system, azimuth Sp_az_pattern of the specular reflection point in the coordinate system of the pattern, incident angle Sp_inc_angle of GNSS signal at specular reflection point, a height of specular reflection point Sp_alt, a latitude of specular reflection point Sp_lat, longitude of specular reflection point Sp_lon, a height angle Sp_theta_antenna of the specular reflection point in the antenna coordinate system, a height angle Sp_theta_body of the specular reflection point in the satellite body coordinate system, a height angle Sp_theta_pattern of the specular reflection point in the pattern coordinate system, an X component of the specular reflection point velocity Sp_vel_x, a Y component of the specular reflection point velocity Sp_vel_y, a Z component of the specular reflection point velocity Sp_vel_z, an X component Tx_vel_x of GNSS satellite speed at the signal transmission time corresponding to the DDM collecting intermediate time, a Y component Tx_vel_y of GNSS satellite velocity at the signal transmission time corresponding to the DDM collecting intermediate time, a Z component Tx_vel_z of GNSS satellite velocity at the signal transmission time corresponding to the DDM collecting intermediate time;
S2.2, the characteristic variable parameters and metadata variables in the L1 level data of Tianmu-1 GPS-R/BDS-R/GLONASS-R/Galileo-R are matched with the significant wave height data of ERA5, Wind speed of ERA5 and sea surface temperature of ERA5, SMAP sea surface salinity (SSS) and OSCAR sea surface current data and ERA5 significant wave height data, WaveWatch III significant wave height data and Jason-3 significant wave height data in time and space, and the data set after time and space matching is obtained.

As an implementation of this embodiment, the S3 includes the following substeps:
S3.1, data filtering is to use basic quality control (QC) flag in Tianmu-1 GNSS-R L1 data, and apply data filtering with a single QC flag bit. Data quality control includes selecting the point of specular reflection point on the ocean (that is, setting SP_surface_type=0); the observed value must be positive, and it needs to be discarded when the value is Nan; when the roll angle of the satellite is greater than 30°, the yaw angle is greater than 5°, or the pitch angle is greater than the absolute value of 10°, the data will be discarded; deleting the detected radio frequency interference (RFI) data; if the uncertainty in the estimated specular point delay and Doppler shift exceeds the preset requirements, delete the data; if the altitude of the satellite is outside the nominal altitude range, delete the data; if the temperature and auto gain control values for the delayed Dopplergram DDM power calibration condition are out of the preset range, delete the data.
S3.2, the data set is divided according to the training set accounting for 60% of the total data set and the test set accounting for 40% of the total data set.

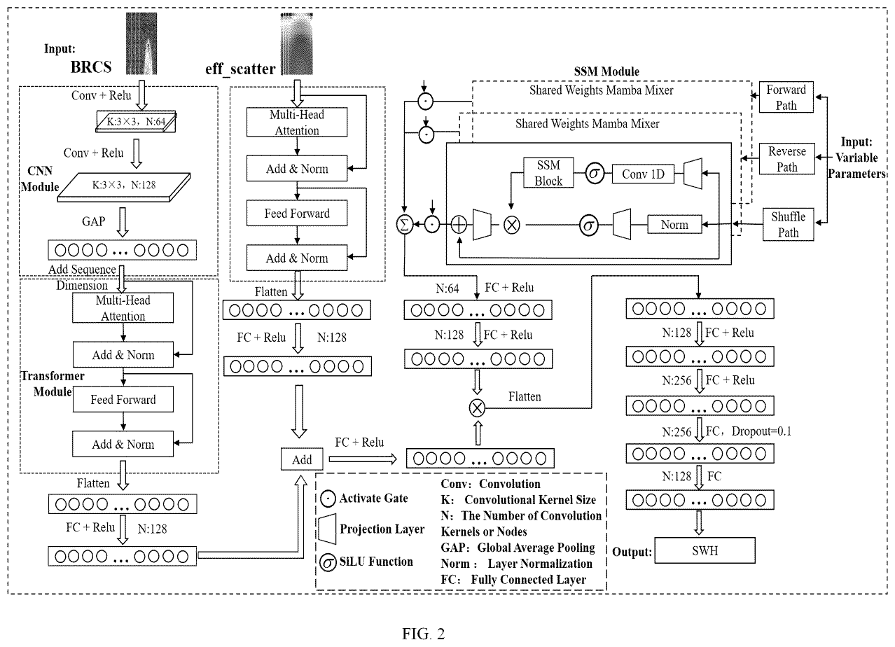

As an implementation of this embodiment, the S4 includes the following substeps:
S4.1, the constructed significant wave height retrieval model is called WaveMambaFormer, the model structure is shown in FIG. 2, the model includes of three models: DDM feature extraction model based on CNN, Transformer model and State Space model (SSM). CNN is very suitable for the processing of local features in images or signals, Transformer has a unique self-attention mechanism, which may capture long-time scale or long-distance dependencies in signals, the dynamic modeling ability, noise suppression ability and adaptability to time-varying processes of SSM model are particularly suitable for describing the complexity and variability of sea surface state. Specifically, firstly, the local spatial information of signals in BRCS is extracted through CNN's multi-layer convolution layer. After convolution operation, using global average pooling may preserve significant features and reduce the amount of parameters, which greatly improves the training speed of the model. Then, these features are input into Transformer to further capture the long-distance dependence and time series relationship; Secondly, due to the highly nonlinear relationship between the fluctuation of ocean surface and the scattering of reflected signals, Transformer may handle this complex relationship and capture the long-range dependence between different time points through the self-attention mechanism, so as to extract the information in eff_scatter from reflected signals more accurately; Finally, the features are extracted from the variable parameters through the dynamic multipath SSM model.

The main part of Transformer module is encoder module, which is used to extract global information. It includes of multi-head attention mechanism, residual connection and Layer Normalization, feedforward neural network and fully connected network. The multi-head attention mechanism includes of multiple self-attention mechanisms, for a single self-attention mechanism, if the input vector matrix is represented by X∈□^{N×D}, then Q ((query), K (key value) and V (value) are obtained by multiplying the input matrix X with three learnable weight matrices W^{Q}, W^{K} and W^{V}, the relevant calculation formulas are as follows:

$$Q = {XW}^{Q} \qquad ( 1 )$$

$$K = {XW}^{K} \qquad ( 2 )$$

$$V = {XW}^{V} \qquad ( 3 )$$

After obtaining the matrices Q, K and V, the output of Self-Attention mechanism may be calculated, and the calculation formula is as follows:

$$Self - Attention ( Q , K , V ) = Softmax ( \frac{Q {K}^{T}}{\sqrt{{d}_{k}}} ) V . \qquad ( 4 )$$

In the formula, d^{k} is the number of columns of the Q and K matrix.

Residual connection may transfer gradient between different layers, effectively alleviating the problem of gradient disappearance. Layer normalization is helpful to accelerate the convergence speed of the model in the training stage and improve the generalization ability of the model.

SSM is able to describe the dynamic changes of the system, especially suitable for time-dependent data modeling, and may handle multiple variables and their interaction at the same time, which is suitable for the modeling of complex systems. SSM comes from the control system theory. The continuous function treated by the original theory includes the state equation and the observation equation. The calculation expression is as follows:

$${h}^{′} ( t ) = Ah ( t ) + Bx ( t ) \qquad ( 5 )$$

$$y ( t ) = Ch ( t ) \qquad ( 6 )$$

In the formula, x(t) is the input sequence, h(t) is the hidden state, and y(t) is the predicted output sequence. SSM is applied to deep learning in discrete form, A and B are discretized by zero-order preserving (ZOH) method, and the time scale parameter is Δ.

$$\overline{A} = exp ( Δ A ) \qquad ( 7 )$$

$$\overline{B} = {( Δ A )}^{- 1} ( exp ( Δ A ) - I ) \cdot Δ B . \qquad ( 8 )$$

After discretization, formulas (1) and (2) may be rewritten as:

$${h}_{k} = \overline{A} {h}_{k - 1} + \overline{B} {x}_{k} \qquad ( 9 )$$

$${y}_{k} = \overline{C} {h}_{k} \qquad ( 10 )$$

The final output y is obtained by the following calculation formula:

$$\overline{K} = ( \overline{C} \overline{B} , \overline{C} \overline{A} \overline{B} , … , \overline{C} {\overline{A}}^{L - 1} \overline{B} ) \qquad ( 11 )$$

$$y = x * \overline{K} \qquad ( 12 )$$

In the formula, L represents the length of the input sequence and K̅ represents the structured convolution kernel.

In the process of model training, Log-Cosh Loss function combines the smoothness of mean square error (MSE) and the robustness of mean absolute error (MAE), which may not only effectively optimize small errors, but also avoid the excessive influence of outliers on the model. The function is especially suitable for the regression task in deep learning model, and may give consideration to high accuracy and robustness. Therefore, the log-cosine loss function is introduced as the loss function, and the calculation formula of log-cosine loss is as follows:

$$L ( y , {y}^{p} ) = {\sum }_{i = 1}^{n} log ( cosh ( {y}_{i}^{p} - {y}_{i} ) ) \qquad ( 13 )$$

In the formula,

$${y}_{i}^{p}$$

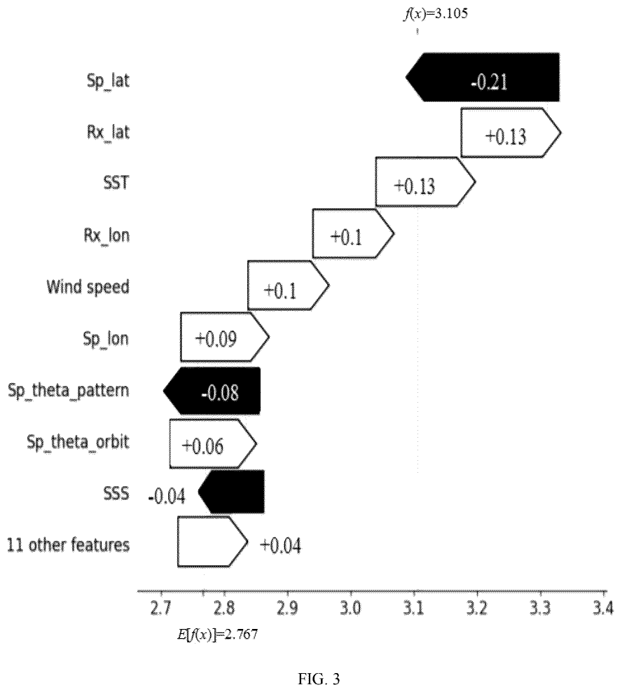

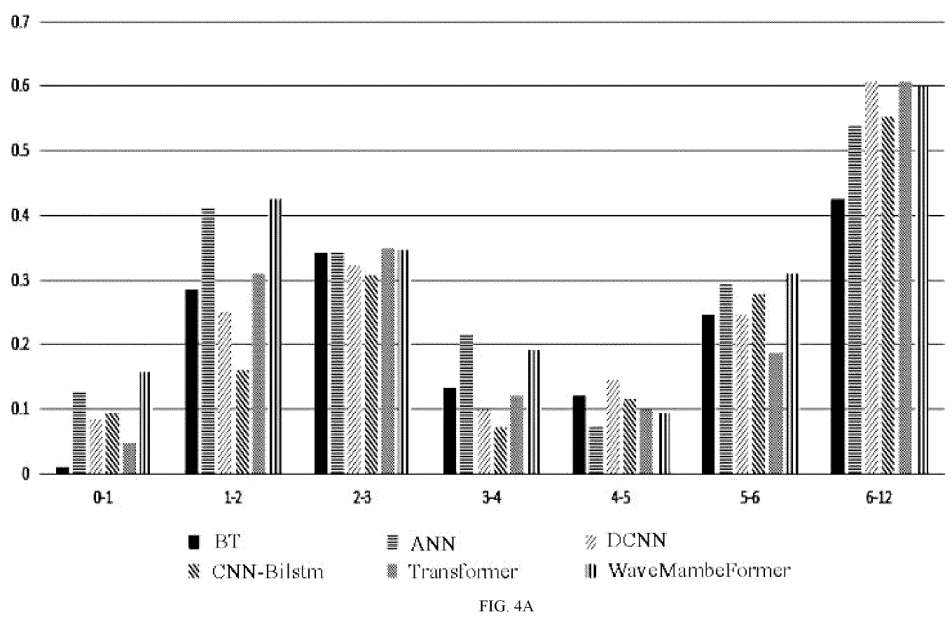

represents the predicted significant wave height and yᵢ represents the reference significant wave height.
in order to use the SHAP explainer to calculate the feature importance and global interpretation and enhance the explainability of the model, FIG. 3 shows the SHAP Waterfall Plot, in which each bar represents the SHAP value of a feature, with positive values representing the positive contribution of the feature to the prediction results and negative values representing the negative contribution, the expected value of the significant wave height of the model proposed by the disclosure is 2.767, and the SHAP value of the final sample is 3.105, where sp_lat has the greatest negative influence in this sample.

Further, in step 4.3, the characteristic variables and metadata variables in the L1 data of Tianmu-1 GPS-R/BDS-R/GLONASS-R/Galileo-R, and the data of ERA5 Wind speed, ERA5 Rain rate, ERA5 sea surface temperature (SST), SMAP sea surface salinity (SSS) and OSCAR sea current are used as the input data for the training of the WaveMambaFormer model, ERA5 significant wave height data is taken as target data, where, the GNSS satellite batch code (Gnss_block_flag) used to generate DDM waveform is helpful to fuse GPS-R/BDS-R/GLONASS-R/Galileo-R data to realize multi-constellation GNSS-R and construct significant wave height retrieval model.

As an implementation of this embodiment, in the S5, the retrieval performance of the model is evaluated by using ERA5, WaveWatch III and Jason-3 significant wave height products as reference data respectively. Root mean square error (RMSE), deviation (Bias), mean absolute percentage error (MAPE) and Pearson correlation coefficient (R) are used as indicators to evaluate the retrieval performance of the model, and the relevant calculation formulas are as follows:

$$R M S E = \sqrt{\frac{1}{m} {\sum }_{i = 1}^{m} {( {y}_{i , M} - {y}_{i , T} )}^{2}} \qquad ( 14 )$$

$$Bias = \frac{1}{m} {\sum }_{i = 1}^{m} ( {y}_{i , M} - {y}_{i , T} ) \qquad ( 15 )$$

$$M A P E = \frac{1}{m} {\sum }_{i = 1}^{m} \vert \frac{{y}_{i , M} - {y}_{i , T}}{{y}_{i , T}} \vert \times 100 \% \qquad ( 16 )$$

$$R = \frac{{\sum }_{i = 1}^{m} ( {y}_{i , M} - \overline{{y}_{M}} ) ( {y}_{i , T} - \overline{{y}_{T}} )}{\sqrt{{\sum }_{i = 1}^{m} {( {y}_{i , M} - \overline{{y}_{M}} )}^{2} {\sum }_{i = 1}^{m} {( {y}_{i , T} - \overline{{y}_{T}} )}^{2}}} \qquad ( 17 )$$

in the formula, m is the number of data samples, y_{i,M} and y_{i,T} are estimated the significant wave heights by the model and obtained from the reference data respectively, y̅_̅{̅M̅}̅ and y̅_̅{̅T̅}̅ are the averages of y_{i,M} and y_{i,T} respectively.

In order to evaluate the difference of retrieval performance of significant wave height of sea surface between different GNSS reflected signals of Tianmu-1, the trained WaveMambaFormer model is used to retrieve the significant wave height of the sea surface, and the retrieval performance is evaluated by using ERA5 significant wave height data, WaveWatch III significant wave height data and Jason-3 significant wave height data as reference data respectively, among the five GNSS reflected signals, BDS-R, GPS-R, Galileo-R, GLONASS-R and Multi-GNSS-R, the retrieval result of BDS-R signal is the best; RMSE, Bias, MAPE and R2 are 0.287 m, −0.003 m, 8.69% and 0.936 respectively; compared with BDS-R signal, the range of significant wave height obtained by Multi-GNSS-R signal retrieval is mainly between 0-12 m, and the wave height range is larger; however, the interval of significant wave height obtained by BDS-R signal retrieval is mainly between 0-8 m, and the wave height range is small. Generally speaking, the Multi-GNSS-R signal retrieval has the best result.

In addition, in order to further evaluate the retrieval performance of the model, the disclosure compares the results obtained by the retrieval of the WaveMambaFormer model with the significant wave height results obtained by the retrieval of Bagged Tree (BT), Artificial Neural Network (ANN), Deep Convolution Neural Network (DCNN), CNN-BiLS™ and Transformer. Table 1, Table 2, Table 3 and Table 4 show the comparison accuracy of significant wave heights retrieved by different models with ERA5 data, WaveWatch III data, Jason-3 c band data and Jason-3 ku band data respectively, where IR is the RMSE improvement rate of WaveMambaFormer model compared with the other five machine learning or deep learning models. It may be seen from Table 2, Table 3, Table 4 and Table 5 that when ERA5 data, WaveWatch III data, Jason-3 c band data and Jason-3 ku band data are used as reference data respectively, the retrieval accuracy of WaveMambaFormer model is better than the other five machine learning or deep learning models. However, due to the difference in the significant wave height range of the model retrieval, the retrieval accuracy obtained by using Jason-3 c band data and Jason-3 ku band data as reference data is better than that obtained by using ERA5 data and WaveWatch III data as reference data, when the significant wave height is in the range of 0-12 m and the ERA5 data is taken as reference data, the optimal RMSE is 0.655 m, and the improvement rate (IR) in RMSE is 12.90%, 8.07%, 20.19%, 26.13% and 12.25% respectively; when the significant wave height is in the range of 0-7 m, the optimal RMSE and Bias are 0.543 m and −0.007 m, and the IR is 19.90%, 4.26%, 19.86%, 25.26% and 15.70%, respectively, when Jason-3 ku band data is used as reference data.

TABLE 2
Accuracy of comparison between significant wave
heights retrieved by different models and ERA5
data (significant wave height range: 0-12 m)

| Model | RMSE(m) | Bias(m) | MAPE(m) | R | IR(%) |
|---|---|---|---|---|---|
| BT | 0.751 | 0.071 | 22.188 | 0.79 | 12.90 |
| ANN | 0.712 | −0.141 | 22.311 | 0.82 | 8.07 |
| DCNN | 0.820 | 0.030 | 23.352 | 0.75 | 20.19 |
| CNN-BiLSTM | 0.886 | 0.026 | 25.172 | 0.71 | 26.13 |
| Transformer | 0.746 | 0.072 | 20.608 | 0.79 | 12.25 |
| WaveMambaFormer | 0.655 | −0.034 | 19.427 | 0.84 | — |

TABLE 3
Accuracy of retrieval of significant wave height
by different models and comparison with WaveWatch3
data (significant wave height range: 0-12 m)

| Model | RMSE(m) | Bias(m) | MAPE(m) | R | IR (%) |
|---|---|---|---|---|---|
| BT | 0.947 | 0.388 | 22.792 | 0.78 | 13.00 |
| ANN | 0.872 | 0.294 | 20.676 | 0.83 | 5.54 |
| DCNN | 0.991 | 0.344 | 23.168 | 0.73 | 16.85 |
| CNN-BiLSTM | 1.038 | 0.340 | 24.834 | 0.70 | 20.64 |
| Transformer | 0.941 | 0.387 | 21.266 | 0.78 | 12.50 |
| WaveMambaFormer | 0.824 | 0.282 | 19.167 | 0.83 | — |

TABLE 4
Accuracy of comparing significant wave heights
retrieved by different models with Jason-3 c band
data (significant wave height range: 0-7 m)

| Model | RMSE(m) | Bias(m) | MAPE(m) | R | IR(%) |
|---|---|---|---|---|---|
| BT | 0.693 | 0.392 | 21.824 | 0.63 | 20.82 |
| ANN | 0.574 | 0.176 | 18.324 | 0.72 | 4.42 |
| DCNN | 0.681 | 0.291 | 22.082 | 0.58 | 19.45 |
| CNN-BiLSTM | 0.727 | 0.308 | 24.011 | 0.52 | 24.56 |
| Transformer | 0.668 | 0.354 | 21.216 | 0.65 | 17.84 |
| WaveMambaFormer | 0.549 | 0.093 | 17.490 | 0.71 | — |

TABLE 5
Accuracy of comparing significant wave heights
retrieved by different models with Jason-3 ku
band data (significant wave height range: 0-7 m)

| Model | RMSE(m) | Bias(m) | MAPE(m) | R | IR(%) |
|---|---|---|---|---|---|
| BT | 0.678 | 0.250 | 24.704 | 0.63 | 19.90 |
| ANN | 0.567 | 0.078 | 19.834 | 0.76 | 4.26 |
| DCNN | 0.677 | 0.184 | 24.597 | 0.62 | 19.86 |
| CNN-BiLSTM | 0.726 | 0.195 | 26.923 | 0.55 | 25.26 |
| Transformer | 0.644 | 0.253 | 22.436 | 0.69 | 15.70 |
| CNN-Mamba- | 0.543 | −0.007 | 20.021 | 0.76 | — |
| Transformer | | | | | |

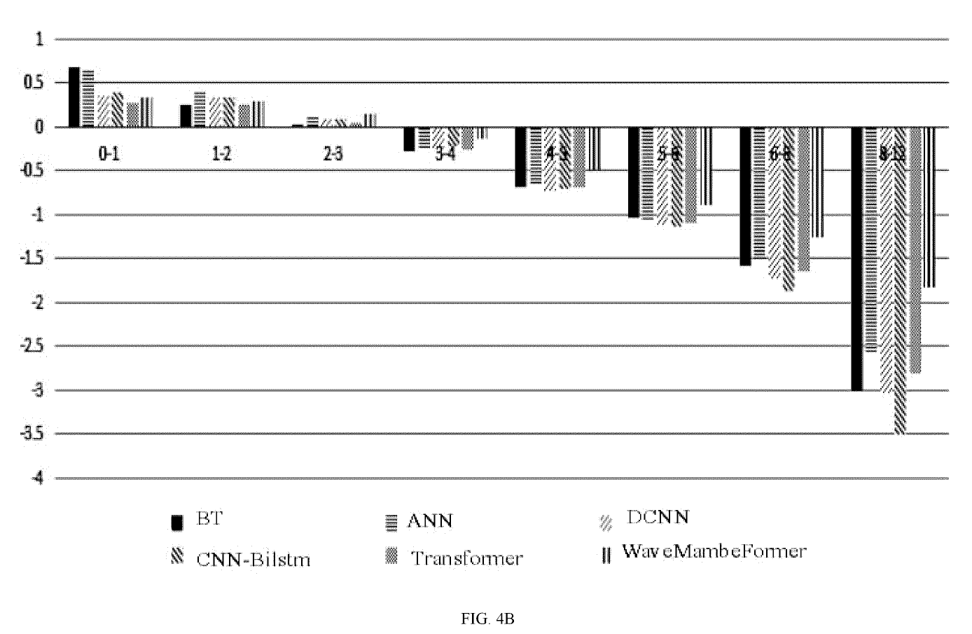

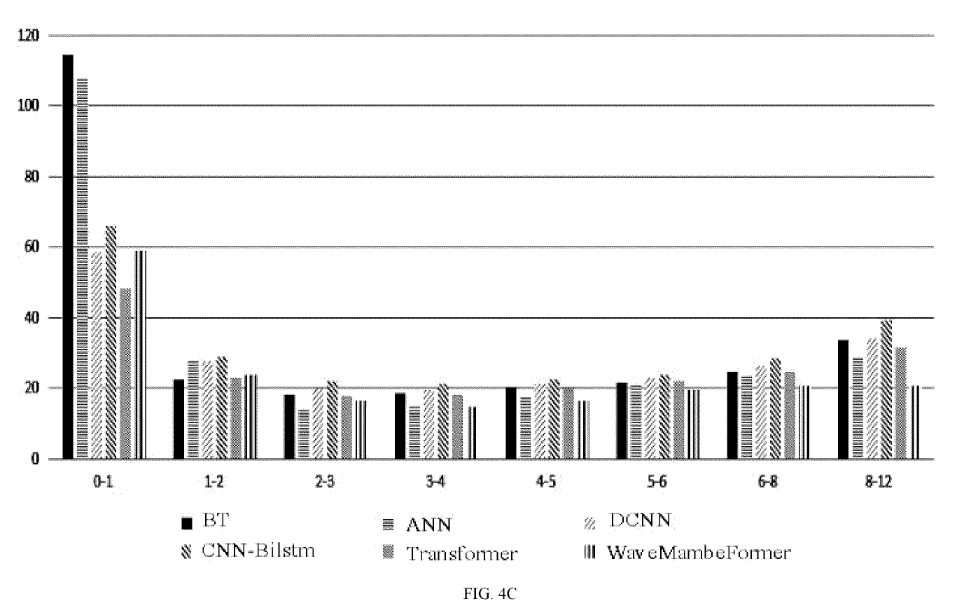

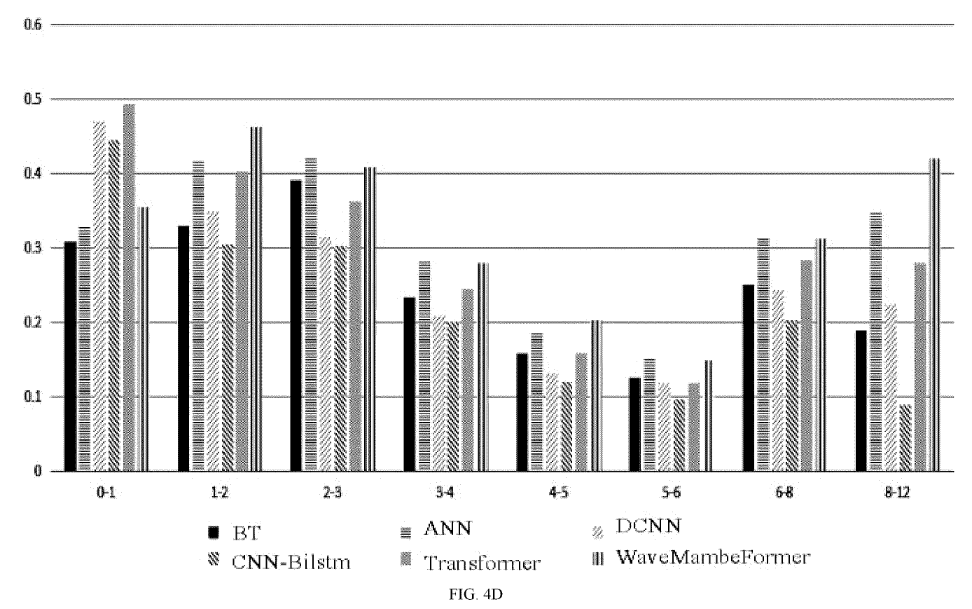

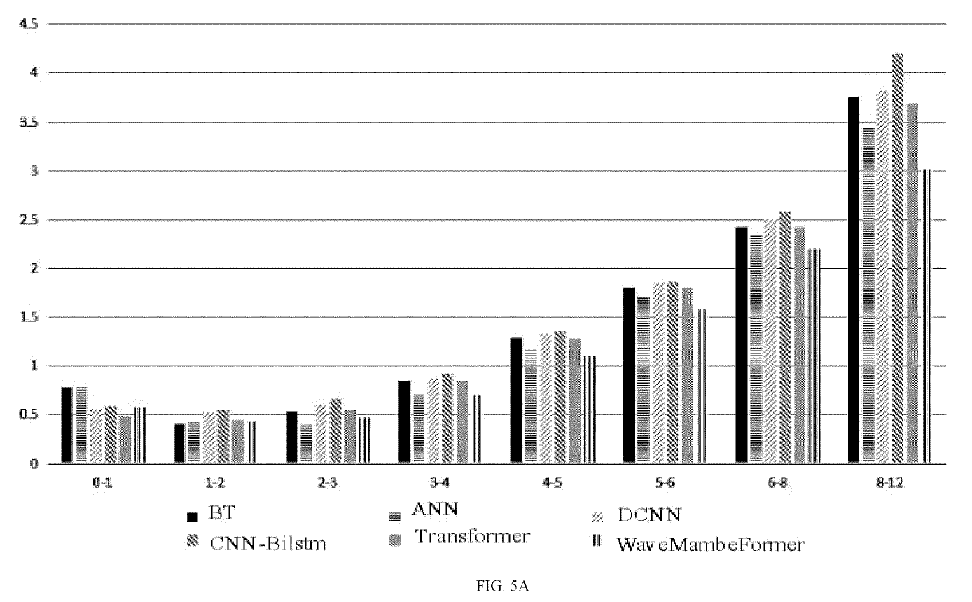

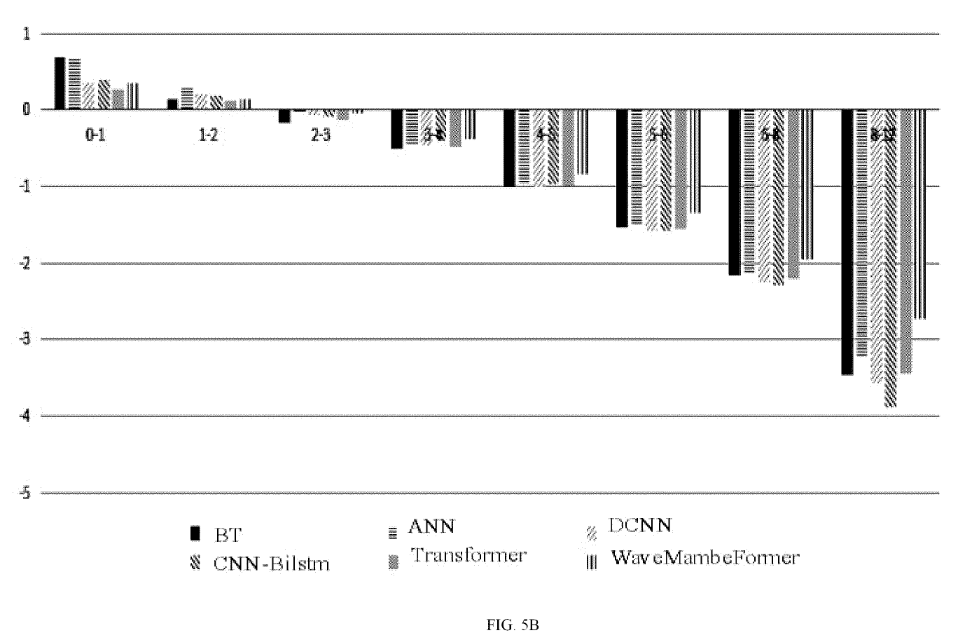

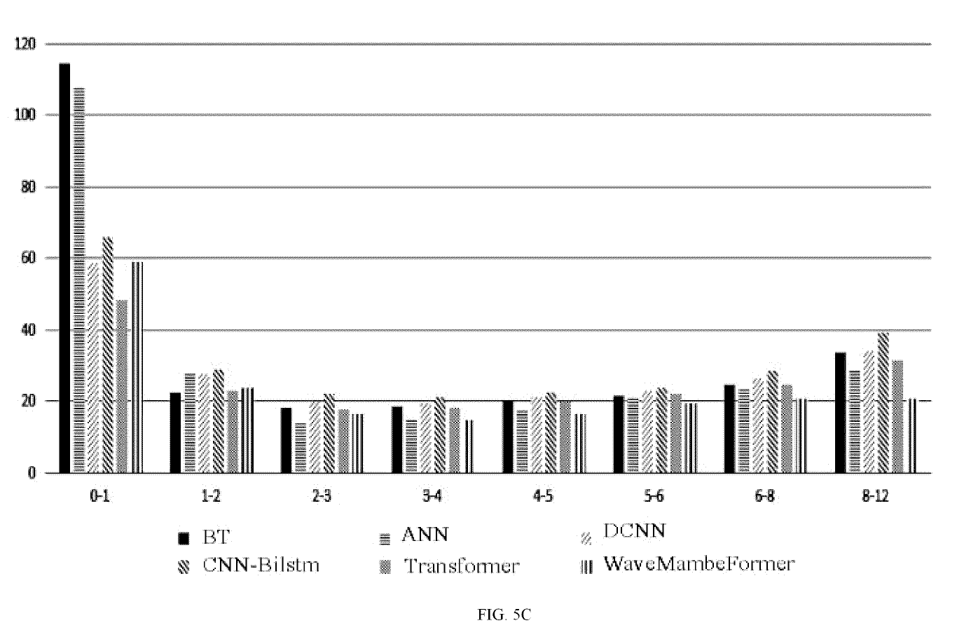

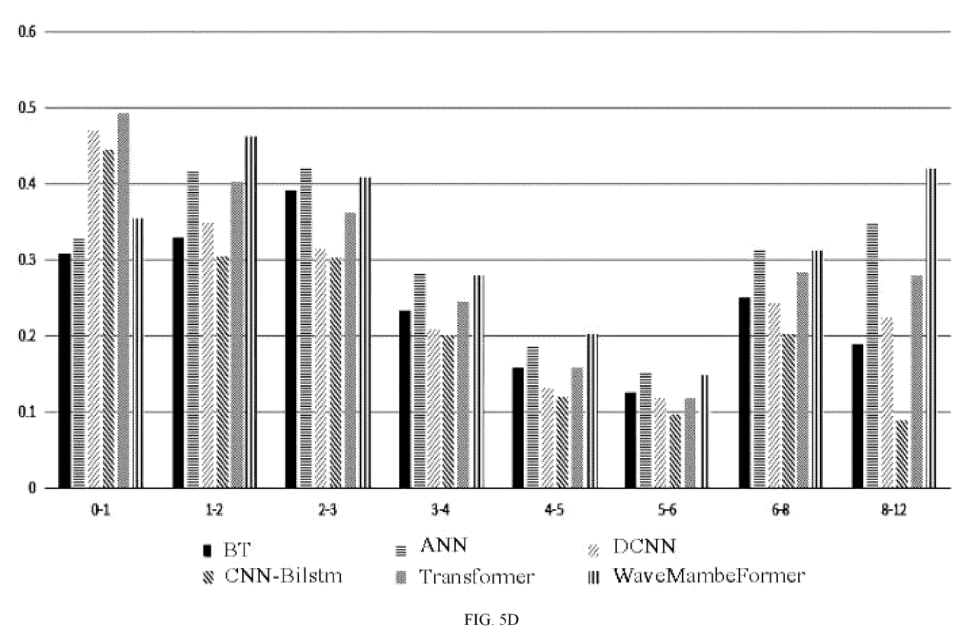

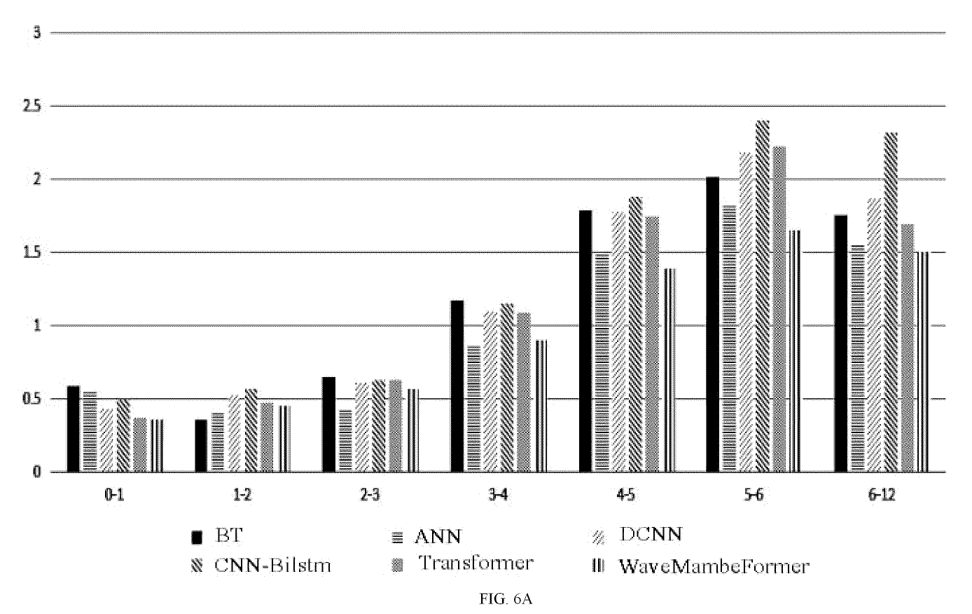

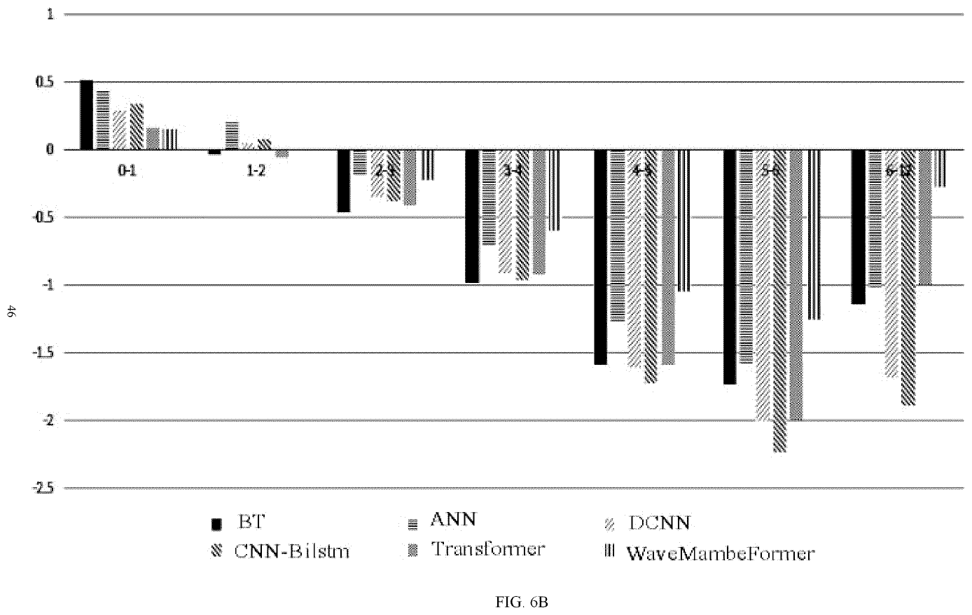

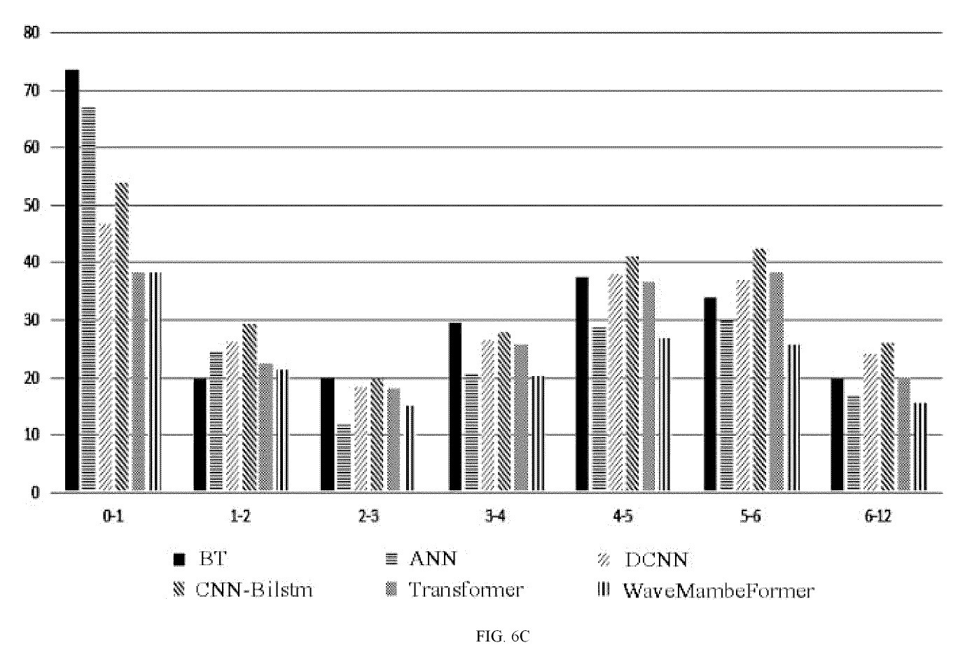

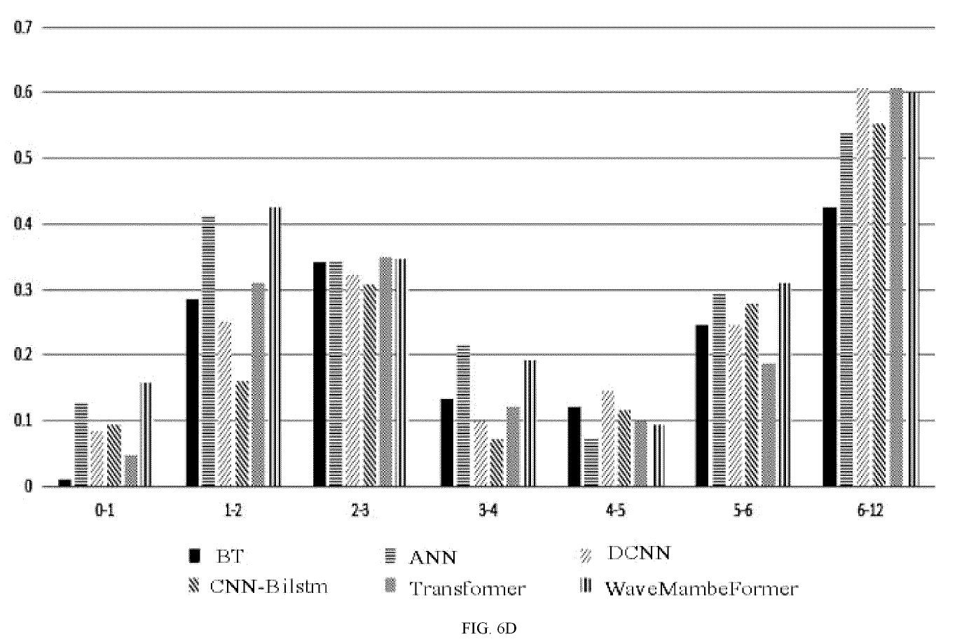

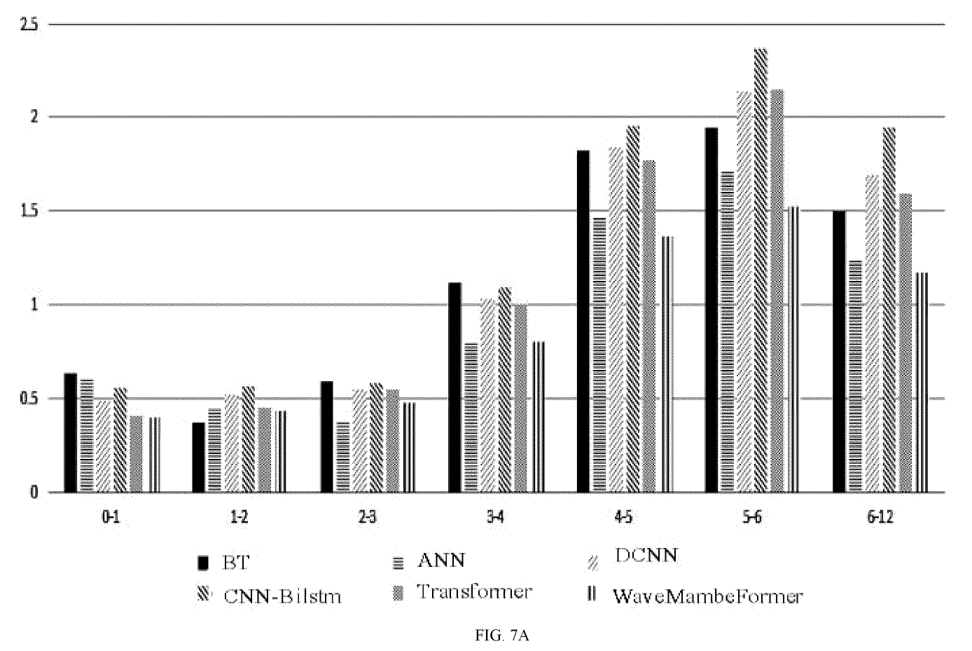

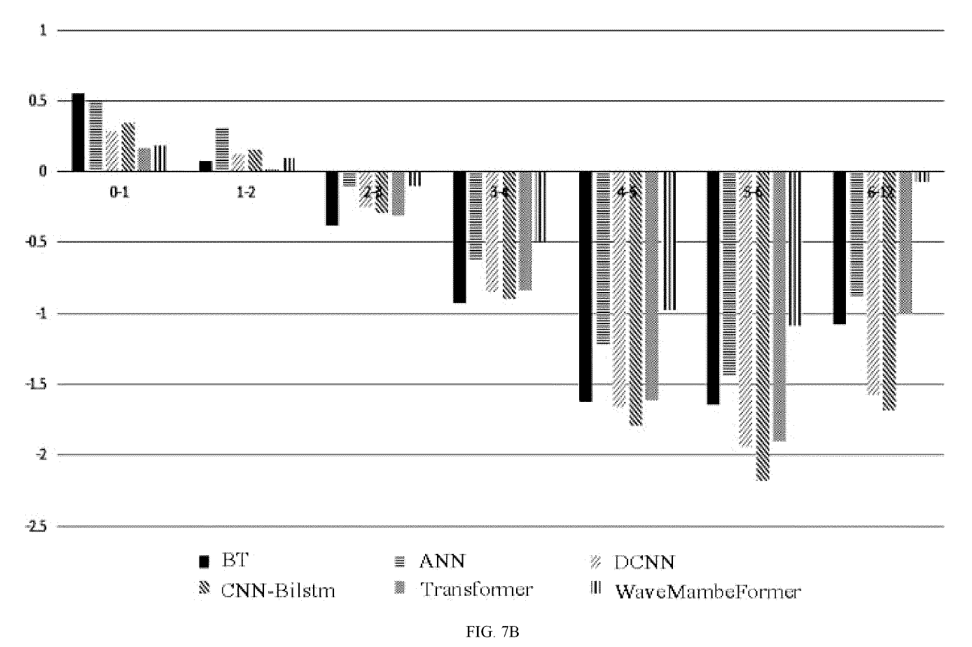

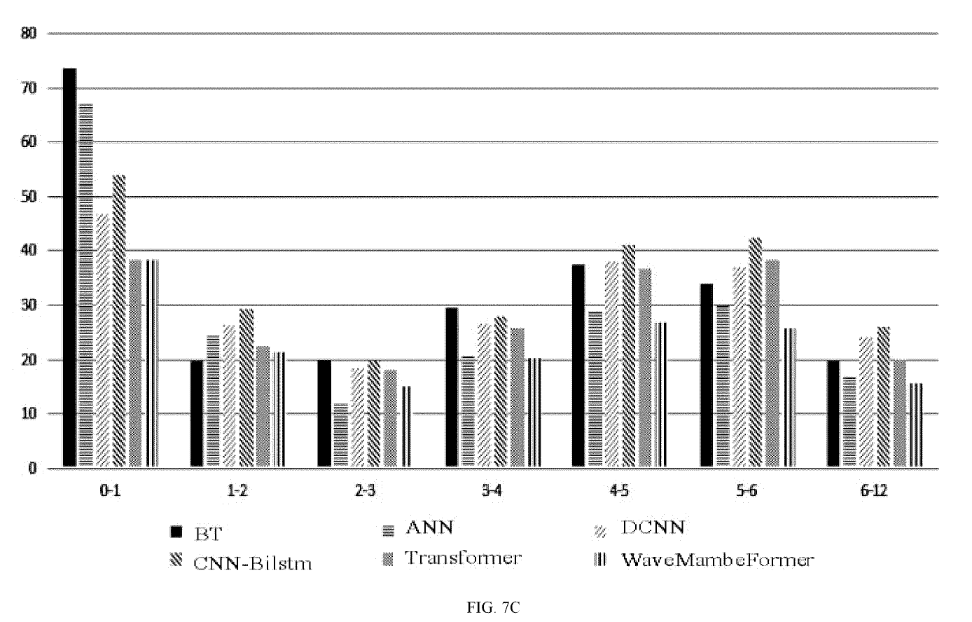

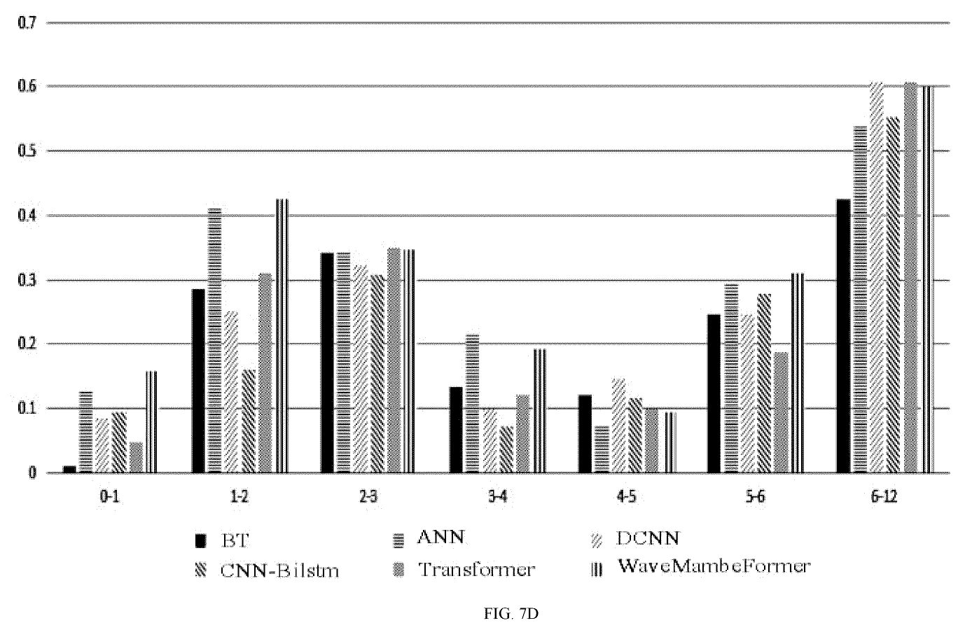

The retrieval performance of each model at different wave heights is also a problem worthy of attention, and it is also an important index to evaluate the quality of the model. FIG. 4A, FIG. 4B, FIG. 4C, FIG. 4D; FIG. 5A, FIG. 5B, FIG. 5C, FIG. 5D; FIG. 6A, FIG. 6B, FIG. 6 C, FIG. 6D and FIG. 7A, FIG. 7B, FIG. 7C, FIG. 7D show the comparison accuracy of retrieval significant wave heights of different models in different significant wave height intervals when the significant wave heights of ERA5, WaveWatch III and Jason-3 are taken as reference data respectively. As may be seen from FIG. 4A, FIG. 4B, FIG. 4C, FIG. 4D; FIG. 5A, FIG. 5B, FIG. 5C, FIG. 5D; FIG. 6A, FIG. 6B, FIG. 6 C, FIG. 6D and FIG. 7A, FIG. 7B, FIG. 7C, FIG. 7D:
(1) Compared with other models, WaveMambaFormer model, Transformer model and artificial neural network model have better retrieval accuracy in different wave height intervals, and have good performance in RMSE, Bias, MAPE and R. With the continuous increase of wave height, the RMSE of the model becomes larger and larger, indicating that the increase of wave height makes the performance of the model worse; MAPE shows a trend of decreasing first and then increasing, that is, the higher the accuracy of the prediction model is in the range of moderate wave height; R shows a trend of increasing first, then decreasing and then increasing. When the significant wave height is 1 m-2 m and the wave height is high, the correlation coefficient is the largest and the linear relationship is strong.
(2) In terms of Bias, when the wave height is less than 3 m, the Bias value of the model is positive and small. However, when the wave height is greater than 3 m, the Bias of the significant wave height obtained by the five retrieval models is less than 0, that is, when the wave height is high, all the five retrieval models are underestimated, especially when the significant wave height of ERA5 and the significant wave height data of WaveWatch III are used as reference data, the Bias values of the models are getting larger and larger with the wave height increasing, the main reason may be that there are few training samples with high significant wave height, which limits the retrieval performance of the model when the wave height is high; when Jason-3 c band data and Jason-3 ku band data are used as reference data, the maximum Bias exists in the model with wave height between 5 m-6 m and 6 m. Compared with the other five machine learning or deep learning models, the retrieval results of WaveMambaFormer model have the best performance in Bias. Although the Transformer model also has better retrieval results under the condition of low wave height, with the increasing wave height, the performance of WaveMambaFormer model in Bias is obviously better than the other five machine learning (or deep learning) models.

The embodiments of that disclosure are intended to cover all such alternatives, modifications and variations that fall within the broad scope of the append claims. Therefore, any omission, modification, equivalent substitution, improvement, etc. made within the spirit and principles of the embodiments of this disclosure should fall within the protection scope of this disclosure.

1. A method for constructing an ocean significant wave height retrieval model under high sea conditions, comprising:
S1, acquiring modeling data, auxiliary data and validating data, wherein the modeling data comprises: spaceborne global navigation satellite system reflectometry (GNSS-R) data and ERA5 significant wave height data; the auxiliary data comprises: ERA5 data, SMAP data and OSCAR data; and the validating data comprises: ERA5, WaveWatch III and Jason 3 significant wave height data;
S2, extracting spaceborne GNSS-R characteristic variable parameters and auxiliary variable parameters, and matching the parameters of the extracted variables by space-time;
S3, carrying out data quality control and data set division on the variable parameters after time-space matching;
S4, using the divided data set to construct and train the WaveMambaFormer model, and using shapley additive explanations (SHAP) explainer to calculate that importance of feature and global interpretation, and to enhance the explainability of WaveMambaFormer model;
S5, using the ERA5, WaveWatch III and Jason-3 significant wave height data as reference data to evaluate the retrieval performance of WaveMambaFormer model,
wherein in the S4, the WaveMambaFormer model comprises three models: delayed doppler diagram (DDM) feature extraction model of CNN, the model of Transformer and the State Space Model, SSM model;
wherein first, the local spatial information of the signal in bistatic radar cross section (BRCS) of a two-base radar scattering cross-section is extracted by a multilayer convolutional layer of CNN, the preset salient features are retained and the number of parameters is reduced using global average pooling after the convolution operation, and then the retained salient features are input into the Transformer to further capture long-range dependencies and temporal relations; and the information in eff_scatter is extracted from the reflected signals by capturing the long-range dependencies between different time points through the self-attention mechanism; finally, the features are extracted from the variable parameters through the dynamic multipath SSM model.

2. The method according to claim 1, wherein in the S2, extracting spaceborne GNSS-R characteristic variable parameters and auxiliary variable parameters, and matching the parameters of the extracted variables by space-time comprises:
S2.1, the extracted spaceborne GNSS-R variable parameters comprises BRCS, effective scattering area (eff_scatter), DDM peak signal-to-noise ratio (Ddm_peak_snr), slope of DDM waveform leading edge (Ddm_sp_les), DDM specular reflection point normalization of bistatic radar cross section (Ddm_sp_nbres), normalized image signal-to-noise ratio (Ddm_sp_normalized_snr), signal-to-noise ratio of DDM specular reflection point (Ddm_sp_snr), DDM trajectory ID (Ddm_track_id), are used to generate GNSS satellite batch code Gnss_block_flag of DDM waveform, the GNSS satellite PRN code Gnss_prn_code of DDM waveform, an altitude Rx_alt of a low-orbit satellite corresponding to the DDM collecting intermediate time, a latitude Rx_lat of the low-orbit satellite corresponding to the DDM collecting intermediate time, a longitude Rx_lon of the low-orbit satellite corresponding to the DDM collecting intermediate moment, a pitch angle Rx_pitch of the low-orbit satellite corresponding to the DDM collecting intermediate time, a roll angle Rx_roll of the low-orbit satellite corresponding to the DDM collecting intermediate time, an X component Rx_vel_x of the low-orbit satellite speed corresponding to the DDM collecting intermediate time, a Y component Rx_vel_y of the low-orbit satellite velocity corresponding to the DDM collecting intermediate time, a Z component Rx_vel_z of the low-orbit satellite velocity corresponding to the DDM collecting intermediate time, a specular reflection point receiver antenna gain Sp_antenna_gain, an azimuth Sp_az_antenna of the specular reflection point in antenna coordinate system, the specular reflection point is in the azimuth, an azimuth Sp_az_body of the specular reflection point in the satellite body coordinate system, an azimuth Sp_az_orbit of the specular reflection point in orbital coordinate system, an azimuth Sp_az_pattern of the specular reflection point in the coordinate system of the pattern, an incident angle Sp_inc_angle of GNSS signal at specular reflection point, a height Sp_alt of the specular reflection point, a latitude Sp_lat of the specular reflection point, a longitude Sp_lon of the specular reflection point, a height angle Sp_theta_antenna of the specular reflection point in the antenna coordinate system, a height angle Sp_theta_body of the specular reflection point in the satellite body coordinate system, a height angle Sp_theta_pattern of the specular reflection point in the pattern coordinate system, an X component Sp_vel_x of the specular reflection point velocity, a Y component Sp_vel_y of the specular reflection point velocity, a Z component Sp_vel_z of the specular reflection point velocity, an X component Tx_vel_x of GNSS satellite speed at the signal transmission time corresponding to the DDM collecting intermediate time, a Y component Tx_vel_y of GNSS satellite velocity at the signal DDM collecting transmission time corresponding to the intermediate time, a Z component Tx_vel_z of GNSS satellite velocity at the signal transmission time corresponding to the DDM collecting intermediate time;
S2.2, the characteristic variable parameters and metadata variables in the L1 level data of Tianmu-1 GPS-R/BDS-R/GLONASS-R/Galileo-R are matched with the significant wave height data of ERA5, EAR5 Wind speed, EAR5 Rain rate and EAR5 sea surface temperature of ERA5, SMAP sea surface salinity (SSS) and OSCAR sea surface current data and ERA5 significant wave height data, WaveWatch III significant wave height data and Jason-3 significant wave height data in time and space, and to obtain the data set after time and space matching.

3. The method according to claim 1, wherein in the S3, data quality control of the variable parameters after time-space matching comprises:
selecting the point of the specular reflection point on the ocean, setting SP_surface_type=0; the observed value must be positive, and the value needs to be discarded when the value is invalid Nan value; when the roll angle of the satellite is greater than 30°, the yaw angle is greater than 5°, or the pitch angle is greater than the absolute value of 10°, the data will be discarded; deleting the detection of radio frequency interference RFI data; if the uncertainty in the estimated specular point delay and Doppler shift exceeds the preset requirements, the data is deleted; if the altitude of the satellite is out of the nominal altitude range, the data is deleted; if the temperature and auto gain control values for the delayed Dopplergram DDM power calibration condition are out of the preset range, the data is deleted.

4. (canceled)

5. The method according to claim 1, wherein in the S4, training the WaveMambaFormer model comprises:
introducing Log-Cosine Loss Log-Cosh Loss function as a loss function, wherein the Log-Cosh Loss is calculated as:
$$L ( y , {y}^{p} ) = {\sum }_{i = 1}^{n} log ( cosh ( {y}_{i}^{p} - {y}_{i} ) )$$
wherein
$${y}_{i}^{p}$$
denotes the predicted sea surface significant wave height and yᵢ denotes the reference significant wave height.

6. The method according to claim 1, wherein in the S4, using SHAP explainer to calculate feature importance and global interpretation, and enhancing explainability of WaveMambaFormer model comprises:
preparing the trained WaveMambaFormer model and data, creating the deep learning SHAP explainer DeepExplainer, then calculating SHAP value based on the test data, and carrying out the feature importance analysis and global interpretation by visualization methods, wherein the visualization methods comprise: Summary plot, Waterfall Plot, Dependence plot and Heatmap plot.

7. The method according to claim 1, wherein in the S5, using the significant wave height data of ERA5, WaveWatch III and Jason-3 as reference data respectively to evaluate the retrieval performance of WaveMambaFormer model comprises:
using a root mean square error (RMSE), Bias, mean absolute percentage error (MAPE) and Pearson correlation coefficient R as indicators to evaluate the retrieval performance of the model, and putting into relevant calculation formulas is below:
$$R M S E = \sqrt{\frac{1}{m} {\sum }_{i = 1}^{m} {( {y}_{i , M} - {y}_{i , T} )}^{2}}$$
$$Bias = \frac{1}{m} {\sum }_{i = 1}^{m} ( {y}_{i , M} - {y}_{i , T} )$$
$$M A P E = \frac{1}{m} {\sum }_{i = 1}^{m} \vert \frac{{y}_{i , M} - {y}_{i , T}}{{y}_{i , T}} \vert \times 100 \%$$
$$R = \frac{{\sum }_{i = 1}^{m} ( {y}_{i , M} - \overline{{y}_{M}} ) ( {y}_{i , T} - \overline{{y}_{T}} )}{\sqrt{{\sum }_{i = 1}^{m} {( {y}_{i , M} - \overline{{y}_{M}} )}^{2} {\sum }_{i = 1}^{m} {( {y}_{i , T} - \overline{{y}_{T}} )}^{2}}}$$
wherein m is the number of data samples, y_{i,M} and y_{i,T} are estimated the significant wave heights by the model and obtained from the reference data respectively, y̅_̅{̅M̅}̅ and y̅_̅{̅T̅}̅ are the averages of y_{i,M} and y_{i,T} respectively.

8. A system for constructing an ocean significant wave height retrieval model under high sea conditions to implement any of the methods according to claim 1, comprising: an acquiring model, an extracting module, a partitioning module, a constructing module and an evaluating module;
wherein the acquisition model is used to acquire modeling data, auxiliary data and validating data, the modeling data comprises: spaceborne GNSS-R data and ERA5 significant wave height data; the auxiliary data comprises: ERA5 data, SMAP data and OSCAR data; and the validating data comprises: significant wave height data of ERA5, WaveWatch III and Jason-3;
the extracting model is used to extract spaceborne GNSS-R characteristic variable parameters and auxiliary variable parameters, and to match the parameters of the extracted variables by space-time;
the partitioning module is used to carry out data quality control and data set partitioning on the variable parameters after time-space matching;
the constructing module uses the partitioned data set to construct and train the WaveMambaFormer model, uses SHAP explainer to calculate that importance of feature and global interpretation, and enhances the explainability of WaveMambaFormer model; and
the evaluating model is used to evaluate the retrieval performance of WaveMambaFormer model by taking the ERA5, WaveWatch III and Jason-3 significant wave height data as reference data respectively.
